(19) United States
(12) Patent Application Publication
(10) Pub. No.: US 2019/0213661 A1
(43) Pub. Date: Jul. 11, 2019

(54) SYSTEM FOR CROWDSOURCED ITEM SELECTION

(71) Applicant: Walmart Apollo, LLC, Bentonville, AR (US)

(72) Inventors: David Blair Brightwell, Bentonville, AR (US); Cristy Crane Brooks, Cassville, MO (US); Benjamin D. Enssle, Bella Vista, AR (US); Greg Bryan, Bentonville, AR (US); Jesse Lee Eaton, Springdale, AR (US); Jeffrey Kerbs, Bella Vista, AR (US)

(21) Appl. No.: 16/225,217

(22) Filed: Dec. 19, 2018

Related U.S. Application Data
(60) Provisional application No. 62/615,966, filed on Jan. 11, 2018.

(51) Int. Cl. G06Q 30/06; G06Q 30/02

(52) U.S. Cl. CPC G06Q 30/0633; G06Q 30/0641; G06Q 30/0631; G06Q 30/0218

(57) ABSTRACT

Examples provide a system for crowdsourced item selection. A request fulfillment component selects a set of one or more items from a plurality of requested items for retrieval by an identified user. A set of items are selected based on an analysis of item data, per-user retrieval score(s), user-provided data, and/or per-user restriction(s). The request fulfillment component analyzes sensor data associated with a set of retrieved items received at an intake area to identify the items retrieved by the identified user and/or a level of compliance with retrieval criteria for the set of items. The request fulfillment component assigns a reward to the identified user, one or more retrieval scores ranking quality of items retrieved by the user, and/or one or more retrieval restrictions are assigned to the user based on the number of retrieved items and the level of compliance with the retrieval criteria.

### BACKGROUND

It is frequently convenient for a user to order items from a store remotely for delivery to the user's residence for pick-up by the user at a future day and/or time rather than travel to the store location and search for those items personally. However, selecting items from display areas for order-fulfillment is frequently a time-consuming, labor-intensive, and expensive procedure for store personnel. A personal shopper can pick items to complete a user's order. However, the personal shopper can be unfamiliar with items on the user's list. Moreover, the personal shopper can have insufficient time to complete the order accurately and/or within the time allowed to gather the requested items.

### SUMMARY

Examples of the disclosure provide a system for customized item selection in grocery order fulfillment. The system includes a memory and one or more processors communicatively coupled to the memory. A selection component selects a set of requested items from a plurality of requested items for retrieval by a user in an item selection area. Each item in the selected set of requested items corresponds to one or more items on a user-provided list of items. An assignment component assigns one or more items in the set of requested items to the user. The assignment component assigns the items based on retrieval criteria for the items. The intake component analyzes sensor data received from at least one sensor device associated with the intake area and the retrieval criteria to identify a set of retrieved items. The set of retrieved items correspond to the one or more items assigned to the identified user. A scoring component generates a retrieval score for the identified user. The retrieval score is generated based on a level of compliance of the set of retrieved items with the retrieval criteria. An incentives generation component generates an incentive for the identified user based on the number of items in the set of retrieved items accepted for at least partial fulfillment of at least one order and the generated retrieval score.

Other examples provide a computer-implemented method for customized item selection in grocery order fulfillment. A user device associated with a user in an item selection area receives user-provided data. The user-provided data includes a user-provided list of items and an amount of time available for item retrieval. The user-provided list of items includes one or more items. A selection component selects a set of requested items from a plurality of requested items having a predetermined retrieval time within the amount of time available for item retrieval. Each item in the selected set of requested items corresponds to one or more items in the user-provided list of items. An assignment component outputs the selected set of requested items to the identified user in response to receiving an acceptance of at least one item in the set of requested items by the identified user, the assignment component removes items rejected by the identified user from the selected set of requested items. An intake component accepts a set of retrieved items received by at least one intake area corresponding to at least one item in the selected set of requested items for at least partial fulfillment of at least one order. The intake component rejects any items received by the at least one intake area failing to correspond to at least one item in the selected set of requested items. A retrieval score associated with the identified user is generated. The retrieval score indicating a level of conformity between the selected set of requested items assigned to the identified user for retrieval and the set of retrieved items received at the intake area.

Still other examples provide a system for crowdsourced item retrieval in grocery order fulfillment. The system includes a memory, at least one processor communicatively coupled to the memory, and a data storage device storing a set of retrieval scores associated with each user in a plurality of users. A selection component identifies a set of users from a plurality of users within an item selection area available to retrieve the number of instances of a selected item based on a user-provided list of items for each user in the plurality of users. The identified item matches an item on the user-provided list of items for each user in the identified set of users. The prioritization component selects a user from the set of users having a highest retrieval score associated with the identified item. A retrieval score indicates a level of accuracy and quality associated with previous sets of items retrieved by the identified user. An assignment component updates a user-provided list of items to add the number of instances of the selected item to the user-provided list of items associated with the selected user. A communications interface component outputs the updated user-provided list of items to a user device associated with the selected user. The updated user-provided list of items includes the additional number of instances of the selected item. A customized reward generator, implemented on the at least one processor, that assigns a customized reward to the selected user based on the number of instances of the selected item received at an intake area.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for crowd-sourced item retrieval for order-fulfillment.

FIG. 2 is an exemplary block diagram illustrating an item selection area.

FIG. 3 is an exemplary block diagram illustrating a request fulfillment component.

FIG. 4 is an exemplary block diagram illustrating a plurality of requested items associated with one or more recipients.

FIG. 5 is an exemplary block diagram illustrating a category of items.

FIG. 6 is an exemplary block diagram illustrating update of a user-provided list of items with a set of requested items assigned to a user.

FIG. 7 is an exemplary block diagram illustrating assigned items associated with a user-provided list of items.

FIG. 8 is an exemplary block diagram illustrating a priority component for selecting a user having a highest retrieval score.

FIG. 9 is an exemplary block diagram illustrating assignment of incentives for retrieval of items.

FIG. 10 is an exemplary block diagram illustrating a restriction component for assigning restrictions.

FIG. 11 is an exemplary block diagram illustrating a database storing item retrieval data.

FIG. 12 is an exemplary graph illustrating item assignment based on per-user retrieval scores.

FIG. 13 is an exemplary flow chart illustrating operation of the computing device to assign items to a user for retrieval based on user-provided data.

FIG. 14 is an exemplary flow chart illustrating operation of the computing device to assign items to a user for retrieval based on an item on a user-provided list of items of the user.

FIG. 15 is an exemplary flow chart illustrating operation of the computing device to assign items to a user for retrieval based a category of an item on a user-provided list of items of the user.

FIG. 16 is an exemplary flow chart illustrating operation of the computing device to assign items to a user for retrieval based on a location of an item on a user-provided list of items of the user.

FIG. 17 is an exemplary flow chart illustrating operation of the computing device to assign items to a user for retrieval based on a retrieval score for the user.

FIG. 18 is an exemplary flow chart illustrating operation of the computing device to assign an item to a user for retrieval based on per-item retrieval score assigned to the user.

FIG. 19 is an exemplary flow chart illustrating operation of the computing device to generate a retrieval score and/or a restriction for a user based on retrieval criteria associated with a retrieved item.

FIG. 20 is an exemplary flow chart illustrating operation of the computing device to generate a retrieval score and/or a restriction(s) based on feedback associated with an item retrieved by the user.

Corresponding reference characters indicate corresponding parts throughout the drawings.

### DETAILED DESCRIPTION

Referring to the figures, examples of the disclosure enable crowdsourced item selection for grocery order-fulfillment. In some examples, a request fulfillment component selects a customized set of items from a plurality of items for retrieval by a given user based on user-provided data, including user preferences, item retrieval time available, and/or user-provided list of items. This enables assignment of items to users that prefer to retrieve those items while preventing items from being assigned to a user that prefers not to handle those items. This further improves user efficiency and user satisfaction while reducing resource usage for order fulfillment.

In other examples, the request fulfillment component selects items for retrieval by a given user based on per-user retrieval scores and/or per-user item restrictions. The scores and restrictions enable the system to assign items to users most capable of properly selecting high quality instances of the items and handling those items according to retrieval criteria. This improves the quality of items selected by users, improves accuracy of order-fulfillment, and reduces resource expenditure associated with item selection for fulfilling grocery orders.

Moreover, the request fulfillment system enables an identified user to shop for one or more online/remote users as the first user shops for themselves in a store. The first user can also shop for a remote second user while waiting in a store to pick-up items within a certain proximity of where the first user is waiting to satisfy whole or partial orders for one or more online/remote users.

Other examples provide a scoring component that rates item selection by users based on feedback received from recipients of the selected items, quality of the selected items, and accuracy of item selection. The rating score is used to disqualify certain users from selecting certain items based on the quality of their item selections. This improves item selection quality and reduces labor associated with order-fulfillment.

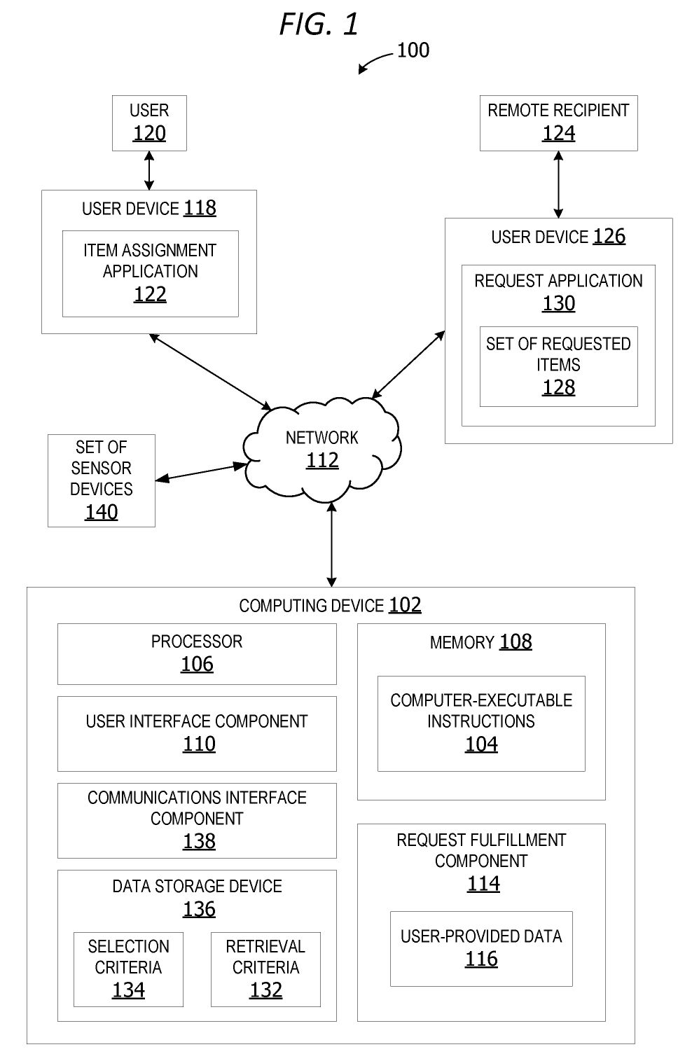

Referring again to FIG. 1, an exemplary block diagram illustrates a system 100 for crowd-sourced item retrieval for order-fulfillment. In the example of FIG. 1, the computing device 102 represents any device executing computer-executable instructions 104 (e.g., as application programs, operating system functionality, or both) to implement the operations and functionality associated with the computing device 102. In this non-limiting example, the computing device 102 is implemented as a server.

In other examples, the computing device 102 includes a mobile computing device or any other portable device. In some examples, the computing device 102 includes a mobile telephone, laptop, tablet, computing pad, netbook, gaming device, and/or portable media player. The computing device 102 can also include devices such as desktop personal computers, kiosks, tabletop devices, industrial control devices, wireless charging stations, and electric automobile charging stations. Additionally, the computing device 102 can represent a group of processing units or other computing devices.

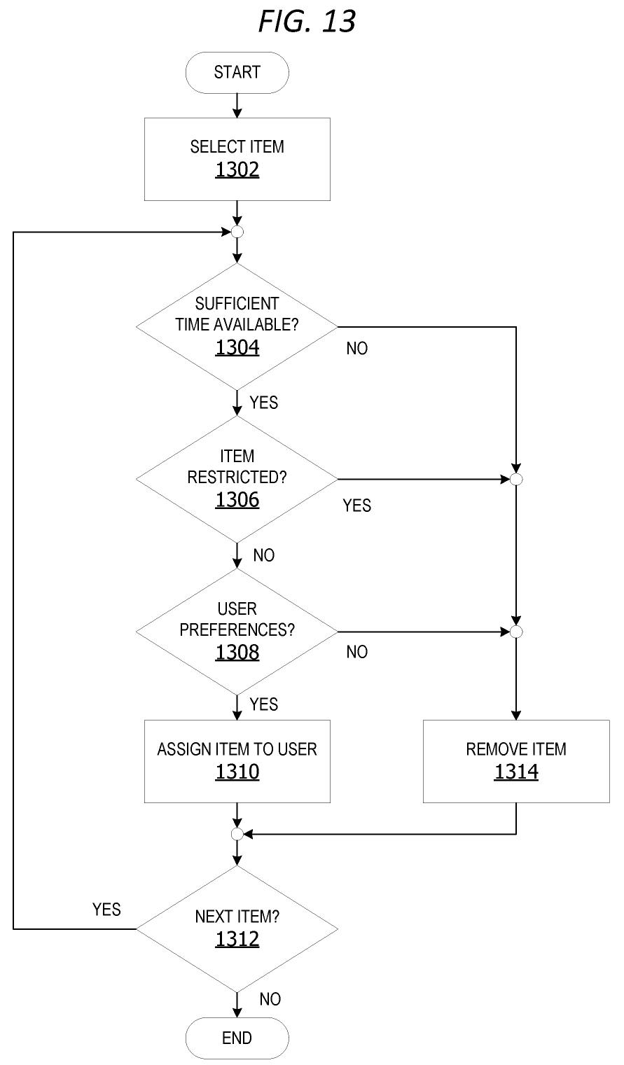

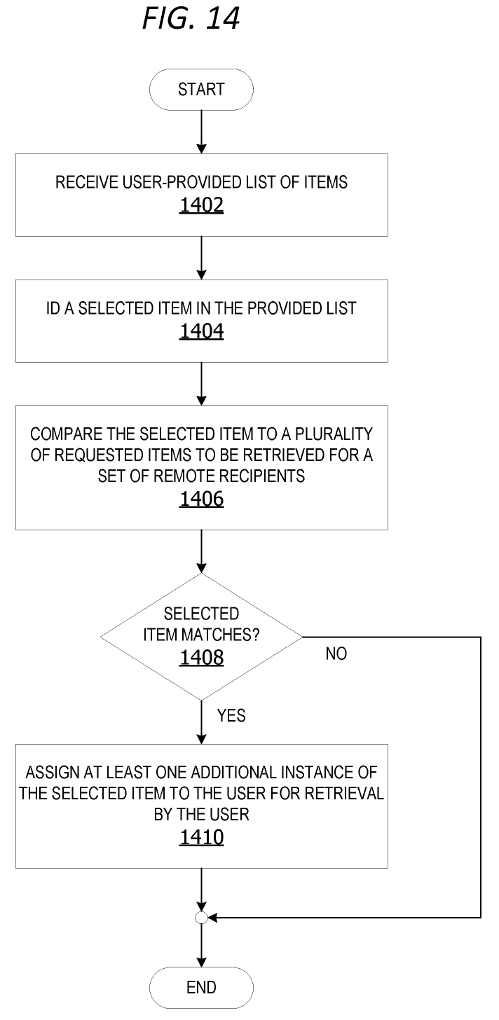

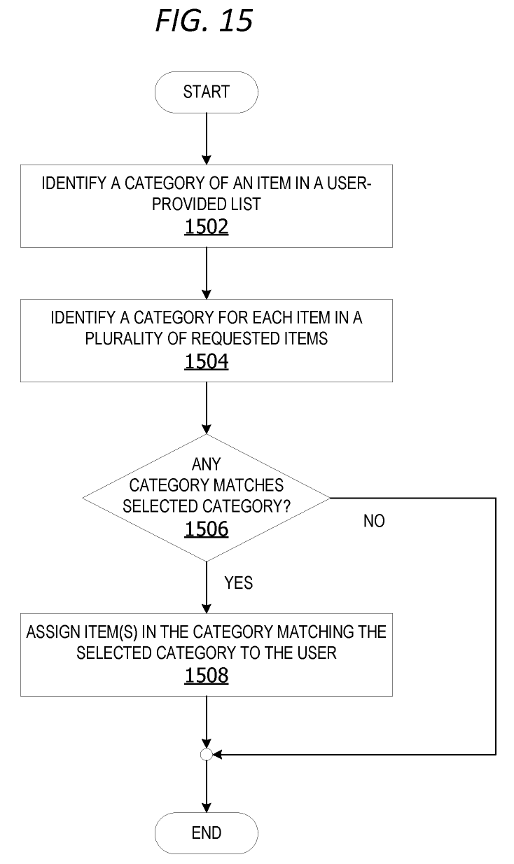

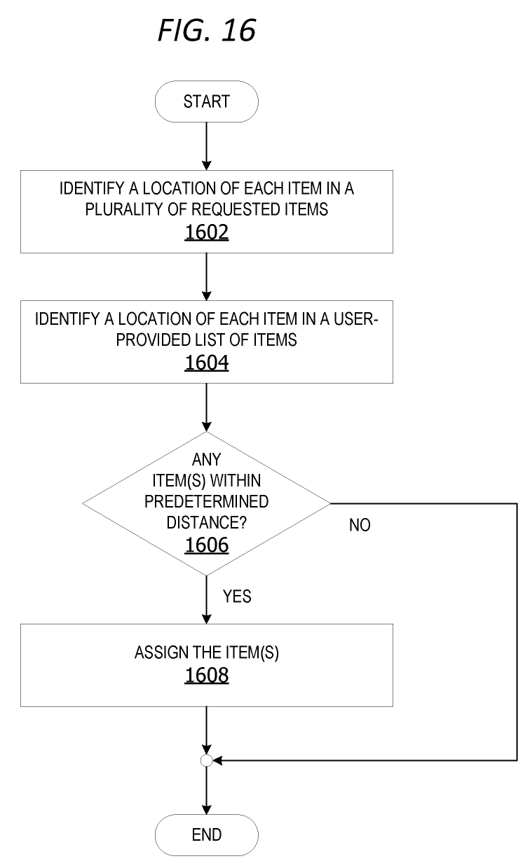

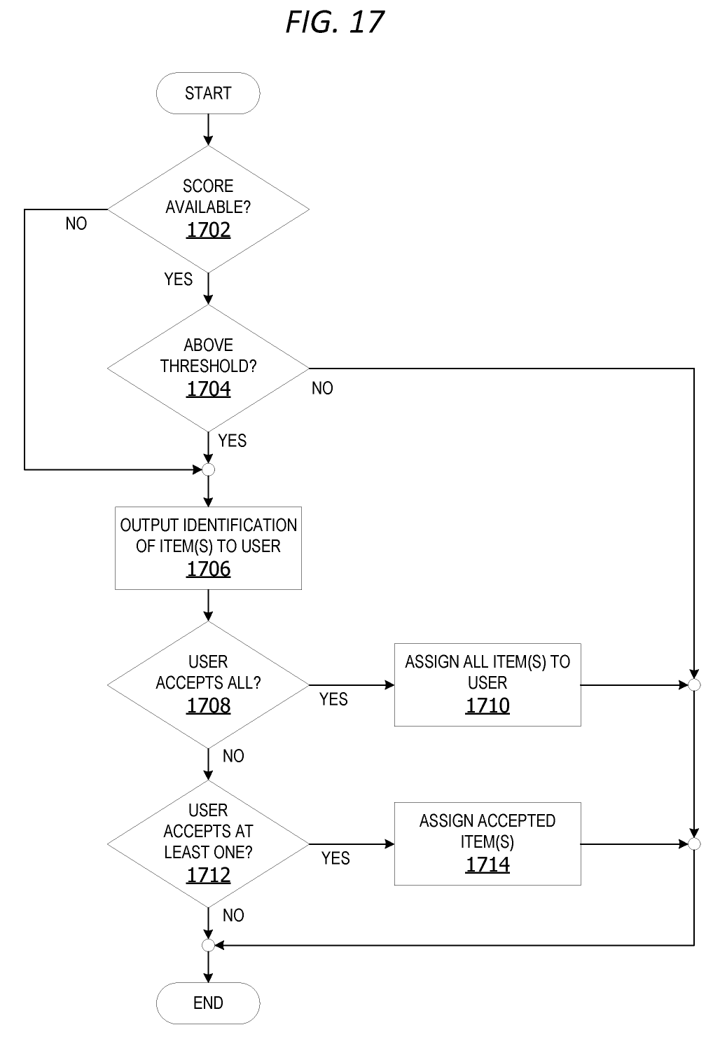

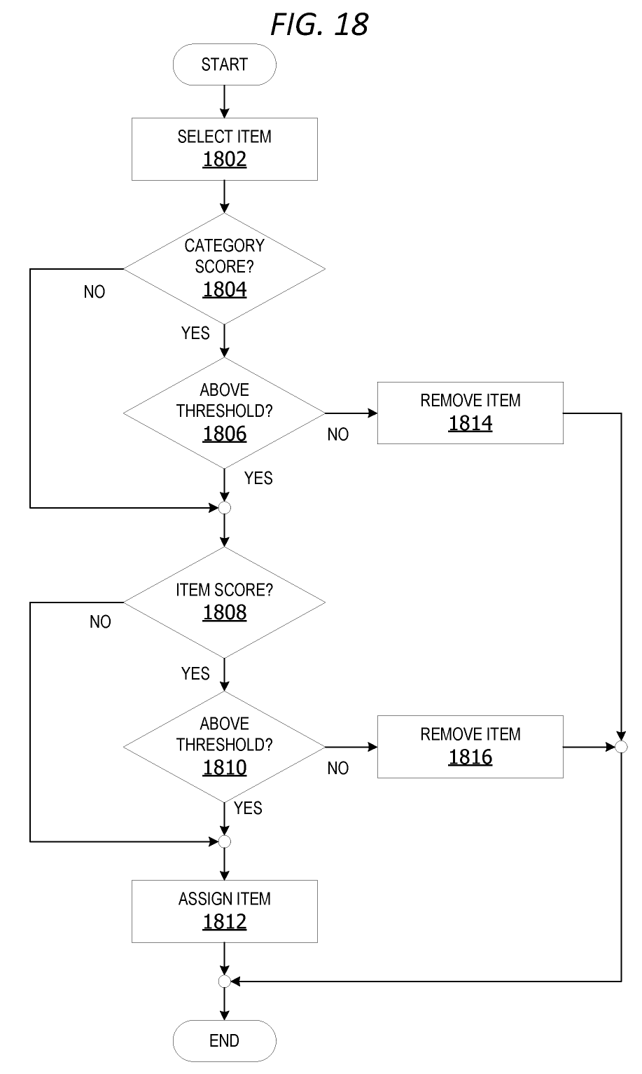

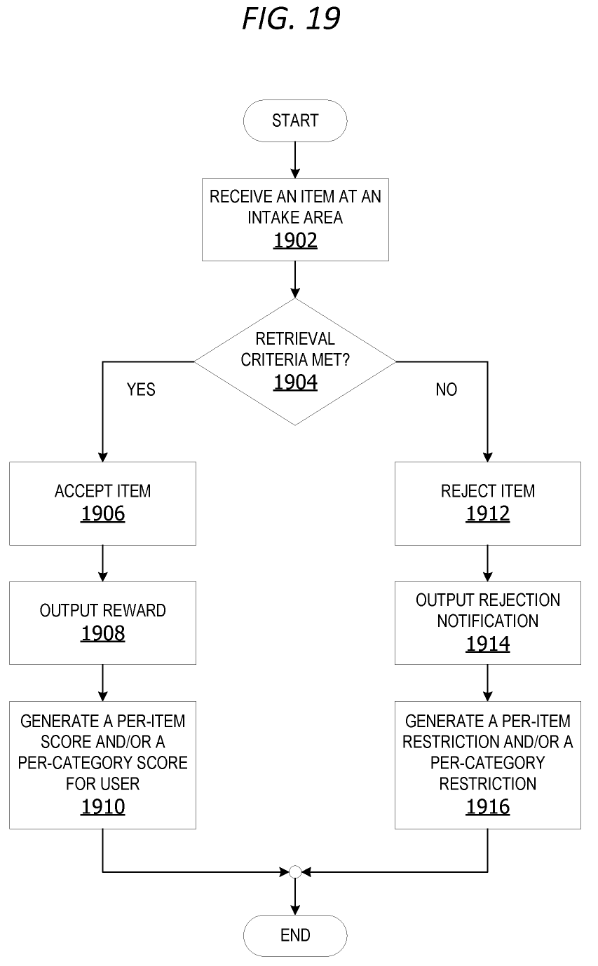

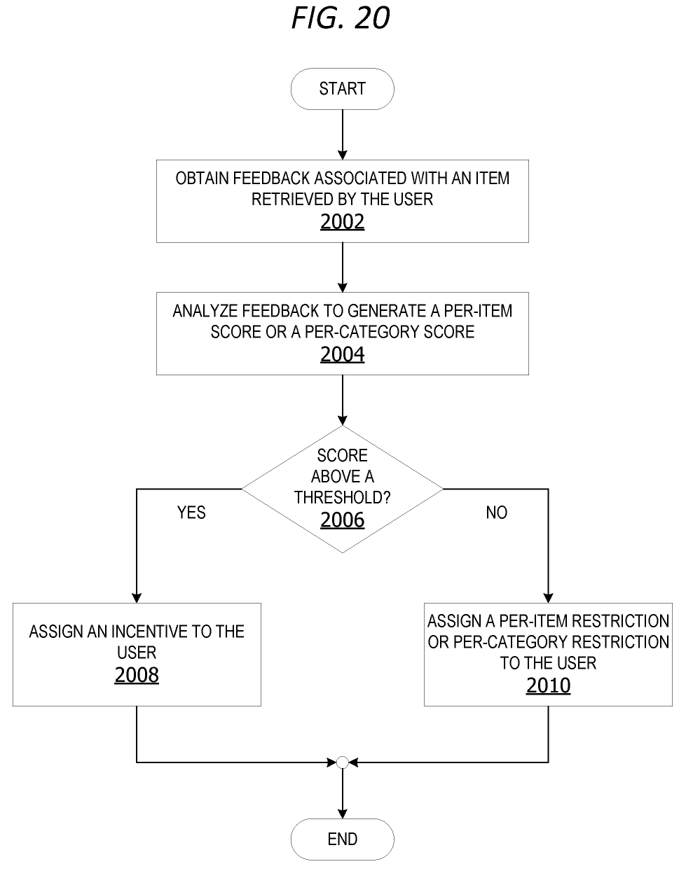

In some examples, the computing device 102 has at least one processor 106, a memory 108, and at least one user interface component 110. The processor 106 includes any quantity of processing units and is programmed to execute computer-executable instructions. The instructions can be performed by the processor 106 or by multiple processors within the computing device 102 or performed by a processor external to the computing device 102. In some examples, the processor 106 is programmed to execute computer-executable instructions 104 such as those illustrated in the figures (e.g., FIG. 13, FIG. 14, FIG. 15, FIG. 16, FIG. 17, FIG. 18, FIG. 19, and FIG. 20).

The computing device 102 further has one or more computer readable media such as the memory 108. The memory 108 includes any quantity of media associated with or accessible by the computing device 102. The memory 108 can be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. For example, the applications can represent downloaded client-side applications that correspond to server-side services executing in a cloud.

The network 112 is implemented by one or more physical network components, such as, but without limitation, routers, switches, network interface cards (NICs), and other network devices. The network 112 can be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

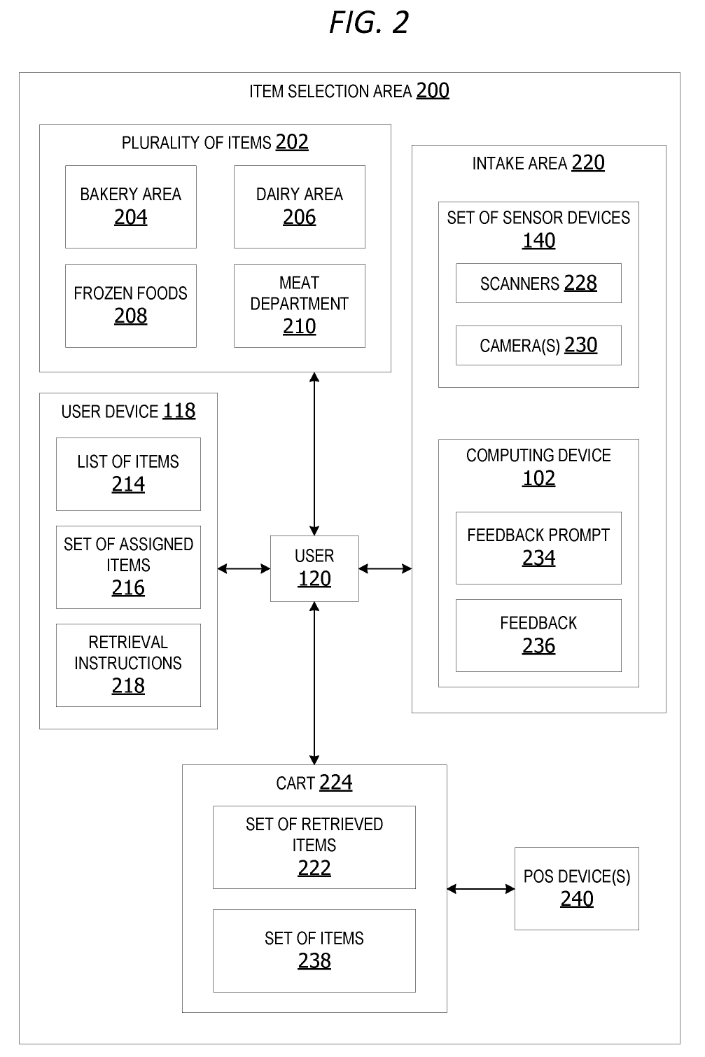

The memory 108 further stores one or more computer-executable components. Exemplary components include an item retrieval request fulfillment component 114. The request fulfillment component 114, when executed by the processor 106 of the computing device 102, causes the processor 106 to receive user user-provided data 116 from a user device 118 associated with an identified user 120 within an item selection area, such as the item selection area 200 in FIG. 2 below. The item selection area is an area including a plurality of items on display for selection by one or more users within the area. The item selection area can include an interior area of a store, an exterior area of a store, or any other portion of a retail environment.

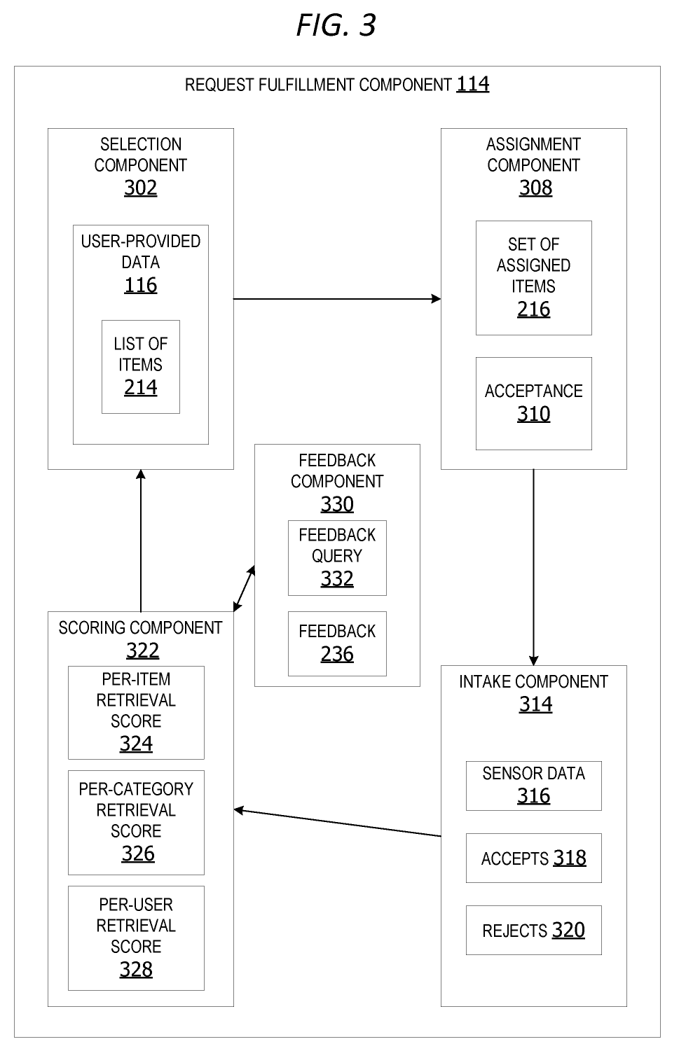

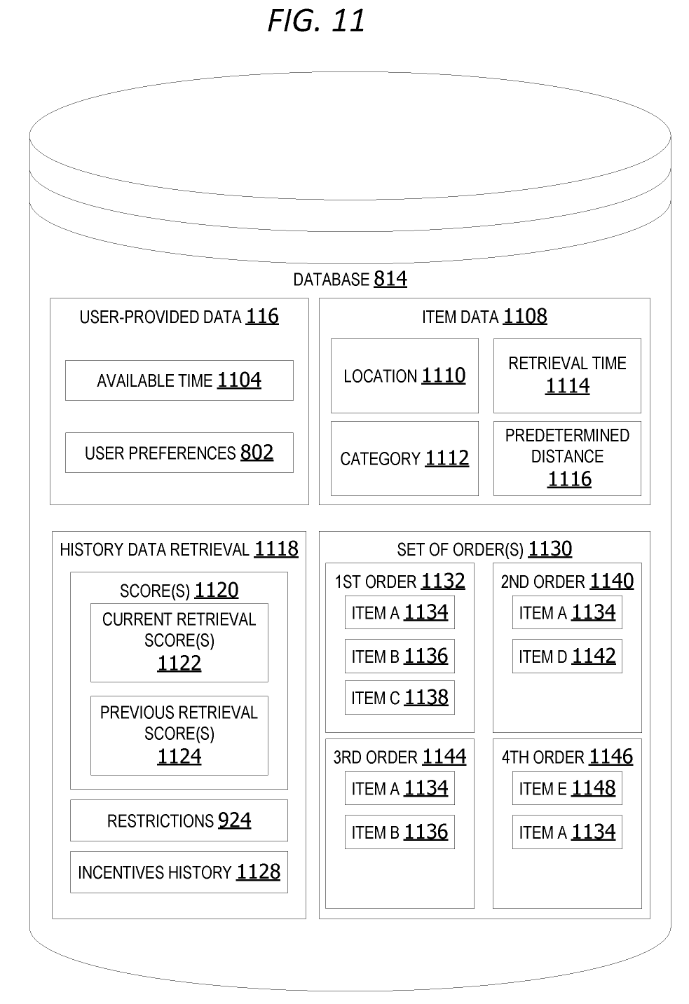

The user-provided data 116 is data input by the user 120, such as, but not limited to, the user-provided data 1102 in FIG. 11. The user-provided data 116 in some examples includes a user-provided list of items, such as, but not limited to, the user-provided list of items 214 in FIG. 2 and/or FIG. 3. A user-provided list of items is a set of one or more items to be obtained by the user within the item selection area for the user and not for a remote recipient.

The user-provided data 116 in other examples includes an amount of time available for item retrieval. The amount of time available for item retrieval is an estimated amount of time the user 120 is available to pick-up items or shop in the item selection area, such as, but not limited to, the available time 1104 in FIG. 11.

The request fulfillment component 114 in some examples selects one or more requested items from a plurality of requested items for retrieval by the user 120. In some examples, each item in the selected set of requested items corresponding to at least one item on the user-provided list of items. In other examples, each item in the selected set of items has a predetermined retrieval time that is less than the user's estimated amount of time available for item retrieval.

The request fulfillment component 114 outputs the one or more requested items assigned to the user 120 to an item assignment application 122 running on the user device 118. The user device 118 is a computing device associated with the user 120. The user device 118 can include a mobile computing device or any other portable device. In some examples, the user device 118 includes a mobile telephone, laptop, tablet, computing pad, netbook, gaming device, and/or portable media player.

The user device 118 in some examples downloads the item assignment application 122 from the computing device 102 via the network 112. In other examples, the user device 118 downloads the item assignment application from an application server, a cloud server, or any other computing device via any network connection.

The item assignment application 122, in some examples, sends the user-provided data 116 to the computing device 102 and receives an assignment of one or more items to be retrieved for one or more remote recipients, such as a remote recipient 124. The remote recipient 124 is a user not physically present in the item selection area. The remote recipient 124 is a user that has ordered one or more items online or via another remote ordering system.

The request fulfillment component 114 analyzes the user-provided data 116 with selection criteria 134 to identify one or more items to assign to the user 120 for retrieval by the user 120. The item assignment application 122 in other examples provides a notification for each assigned item for retrieval by the user and a retrieval time for each item. The item assignment application 122 can also provide an alarm or alert in the application that notifies the identified user 120 that the assigned retrieval time is about to expire. The notification can include the retrieval time, an indication of how much time remains prior to the expiration of the retrieval time, a location of the item associated with the retrieval time that is about to expire, and/or a location of a nearest item intake area inside the item selection area where the item should be delivered prior to expiration of the retrieval time.

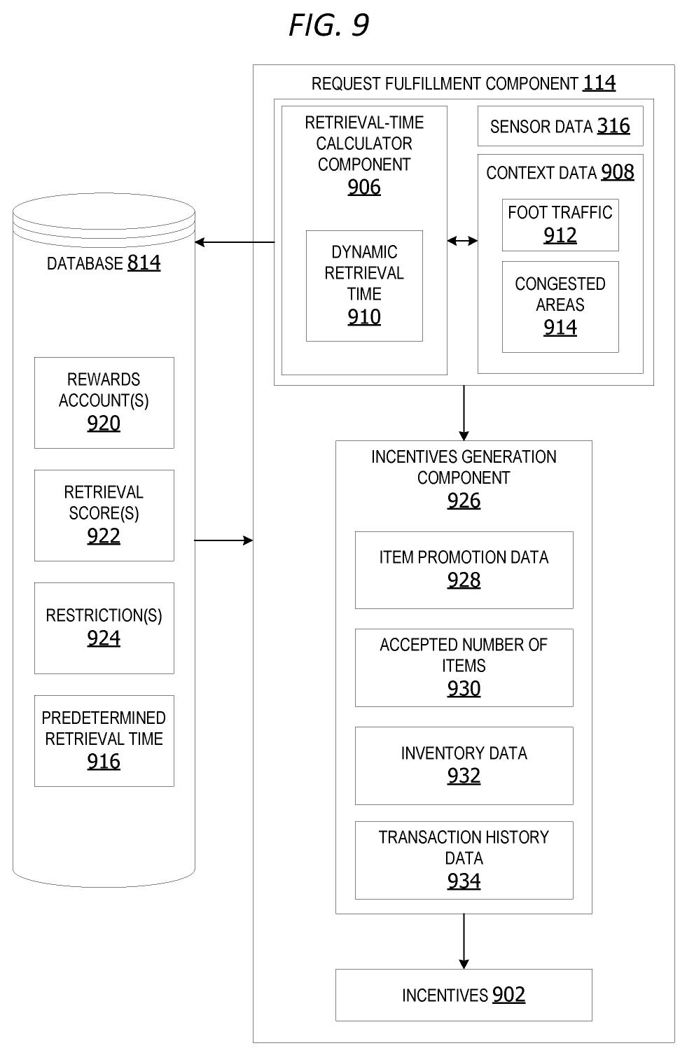

In some examples, the request fulfillment component 114 uses sensor data and/or the user-provided list of items (shopping list) to determine the user's current location and/or identify areas within the item selection area the user plans to visit while shopping. The sensor data is data generated by one or more sensor devices, such as, but not limited to, the sensor data 316 shown in FIG. 3 and/or FIG. 9 below.

The request fulfillment component 114 uses the sensor data and user-provided list of items to identify requested items located within a proximity to the identified user and/or identify a nearest intake area for drop-off of selected items.

The sensor data is generated by one or more sensor devices in a set of sensor devices 140 associated with the item selection area. The set of sensor devices 140 can include one or more proximity sensor(s), one or more scanner(s), one or more image capture device(s), one or more pressure sensor(s), one or more weight sensor(s), one or more beacon transmitter(s), one or more beacon receiver(s), or any other type of sensor devices. The image capture devices include one or more cameras, infrared imaging devices, or any other type of image capture device. The scanners can include radio frequency identifier (RFID) tag readers, barcode readers, hand-held scanners, mounted scanners, matric barcode readers, or any other type of scanner.

The set of sensor devices 140 can include one or more sensors associated with the item selection area. In other examples, the set of sensor devices 140 can include one or more sensors associated with one or more intake areas. However, some of the sensor devices can be associated with shelves, aisles, an entrance/exit, or other areas of the item selection area not limited to the intake area(s).

In some examples, the remote recipient 124 downloads a request application 130 from the computing device 102, an application server, a cloud server, or other provider of the request application 130. The request application 130 enables the remote recipient 124 to remotely send the set of requested items 128 to the computing device 102 to order the set of requested items for delivery to the remote recipient 124 or pick-up by the remote recipient 124 at a future date and/or time.

The selection criteria 134 is a set of one or more rules for selecting one or more items to be assigned to a given user for retrieval by the given user. The selection criteria 134 can specify that a given user only retrieve non-food items. In another example, the selection criteria 134 specifies that a user can only retrieve an item if the estimated retrieval time for that item is less than the user's estimated time available for retrieving items.

The request fulfillment component 114 sends the assigned items selected for retrieval by the user 120 to the user device 118 with retrieval criteria 132. The retrieval criteria 132 is a set of one or more rules for retrieving items. In an example, retrieval criteria 132 specifies that the user 120 place items being retrieved for a remote recipient 124 in a separate basket or a different cart than any items the user 120 is selecting for purchase by the user 120 for the user's own use.

In some example, the user device 118 associated with the user includes a scanner for scanning a barcode or other identifier associated with each item. The user scans the barcode or identifier associated with each item the user selects as the user places the item in the cart. The item assignment application 122 verifies the user has selected the correct assigned items in compliance with the retrieval criteria.

In other examples, the retrieval criteria 132 specifies a maximum retrieval time for one or more items. For example, if the remote recipient 124 indicated a desire to pick-up the set of requested items 128 in one-hour, the retrieval criteria 132 specifies that the user 120 select the assigned item(s) and deliver them to an intake area within a retrieval time that is less than one-hour to ensure items in the set of requested items 128 are ready for pick-up by the remote recipient 124 on-time.

The user 120 selects one or more of the items in the set of requested items 128 assigned to the user 120. The user 120 delivers the requested items selected by the user 120 to an item intake area in the store, such as the intake area 220 in FIG. 2, for at least partial fulfillment of at least one order received from at least one remote recipient, such as the remote recipient 124. The request fulfillment component 114 provides an incentive to the user 120 as a reward for selecting the items requested by the remote recipient 124 in accordance with the retrieval criteria 132.

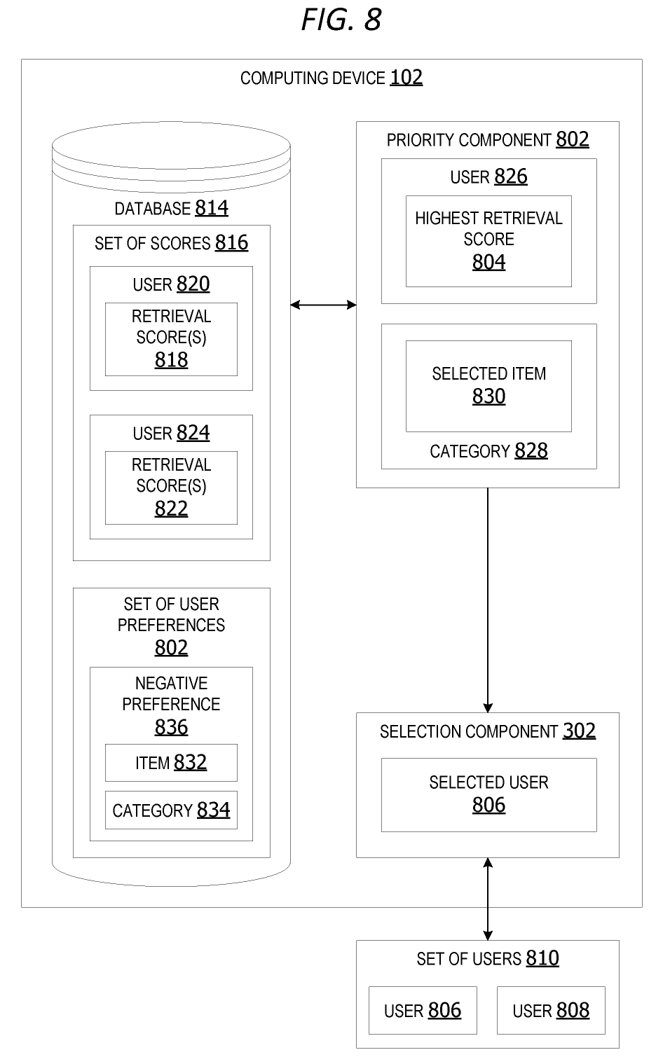

In some examples, the selection criteria 134, the retrieval criteria 132, and/or other data is stored locally on a data storage device 136. The data storage device 136 can include a set of one or more data storage devices storing data. The data storage device 136 can be implemented as one or more types of data storage devices, such as, for example, one or more rotating disks drives, one or more solid state drives (SSDs), and/or any other type of data storage device. The data storage device 136 in some non-limiting examples includes a redundant array of independent disks (RAID) array. In other examples, the data storage device 136 includes a database, such as, but not limited to, the database 814 shown in FIG. 8, FIG. 9 and/or FIG. 11 below.

The set of requested items 128 in some examples is received from one or more user devices associated with one or more remote recipients via a communications interface component 138. Likewise, the one or more items assigned to the user 120 can be output to the user device 118 via the communications interface component 138.

In some examples, the communications interface component 138 includes a network interface card and/or computer-executable instructions (e.g., a driver) for operating the network interface card. Communication between the computing device 102, the user device 118, the user device 126, and/or other devices can occur using any protocol or mechanism over any wired or wireless connection. In some examples, the communications interface component 138 is operable with short range communication technologies such as by using near-field communication (NFC) tags.

In this example, the user 120 sends the user-provided data 116 to the computing device 102 and/or receives notification of assigned items for retrieval by the user 120 using a separate user device 118 connected to the computing device 102 via the network 112. However, in other examples, the user 120 provides the user-provided data 116 directly to the computing device 102 via the user interface component 110. For example, the computing device 102 can include a kiosk providing the user interface for entering the user-provided data 116 and receiving assigned item(s) for retrieval.

In some examples, the user interface component 110 and/or any other input/output device is provided to output the assigned item(s) for retrieval to the user 120. For example, a list of one or more items to be retrieved by the user and the retrieval criteria 132 can be printed out to the user on a printer device associated with the computing device 102 or kiosk.

The user interface component 110 component includes a graphics card for displaying data to the user and receiving data from the user. The user interface component 110 component can also include computer-executable instructions (e.g., a driver) for operating the graphics card. Further, the user interface component 110 component can include a display (e.g., a touch screen display or natural user interface component 110) and/or computer-executable instructions (e.g., a driver) for operating the display. The user interface component 110 component can also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user can input commands or manipulate data by moving the computing device 102 in a particular way.

In some examples, the user interface component 110 receives the user-provided data 116 entered manually by a user. The user-provided data 116 can include the user-provided list of items and/or an amount of time available for retrieving items. In other examples, the user-provided data 116 is received from the user device 118 via the network 112.

In one non-limiting example, the user 120 logs-in to the system 100 via the item assignment application 122 running on the user device 118 or via the user interface component associated with a kiosk or other computing device, such as computing device 102 associated with the item selection area. The user enters the amount of time the user has available for item retrieval and/or a user-provided list of items if the user intends to make a purchase. The user may not have a user-provided list of items if the user is waiting for a service, such as eye glasses, auto services, pharmacy service, or other service. The request fulfillment component 114 outputs the set of requested items 128 with retrieval criteria 132 to the user via the user device 118 or via the user interface component 110. In other examples, the set of requested items assigned to the user and the retrieval criteria 132 can be printed out in a hardcopy form via a printer device. The output list of items for retrieval can include a printed bar code corresponding to each assigned item for retrieval. The user can scan the barcode on the list as the user picks up each item to ensure the correct item is retrieved. The barcodes can be provided on a printout list of the item or on a digital list provided via a user interface on the user device 118.

If the user accepts the offered items for retrieval subject to the retrieval criteria, the set of requested items 128 are assigned to the user for retrieval on behalf of one or more other remote users that are not physically present in the item selection area. The user 120 retrieves those items and drops them off at an intake area or other drop-off location. An order-filler checks the items for quality control and packs the items for the one or more remote users. The request fulfillment component 114 assigns an incentive to the user as a reward for retrieving requested items accurately and/or with positive feedback.

FIG. 2 is an exemplary block diagram illustrating an item selection area 200. The item selection area 200 is an area including a plurality of items on display for selection by one or more users within the area. The item selection area 200 can include an interior area of a store, an exterior area of a store, or any other portion of an item display environment. The item selection area 200 in some examples is a public or semi-public area in which customers shop for one or more items in a plurality of items 202. The plurality of items 202 can include any type of items, such as, but not limited to, comestibles (food items), pet supplies, tools, clothing items, sports equipment, craft supplies, games, toys, electronic items, and/or any other types of items.

The item selection area 200 can be sub-divided into one or more other areas based on a type or category of items found in each sub-divided area. For example, the item selection area 200 can include a bakery area 204 for bread and other bakery items, a dairy area 206 for milk and other dairy-related items, a frozen foods 208 area for frozen food items, a meat department 210 for meat-related items, and/or any other sub-divided areas for other categories of items.

In some examples, a user-provided list of items 214 is utilized to select items for retrieval by the user. The user-provided list of items 214 is a list of one or more items the user 120 plans to obtain from the item selection area 200 during the user's current visit to the item selection area 200. An item in the user-provided list of items 214 is an item for the user 120 and not an item for a remote recipient or fulfillment of an order for a third party or another remote recipient. The user-provided list of items 214 in some examples includes a shopping list.

The user-provided list of items 214 can be provided to the request fulfillment component manually via a kiosk or the user can upload the user-provided list of items 214 via an item assignment application running on a user device 118 associated with the user 120, such as, but not limited to, the item assignment application 122 in FIG. 1.

The user 120 receives a set of one or more assigned items 216 for retrieval by the user and delivery to an intake area 220. In some examples, the items are assigned to users in a first-in and first-out (FIFO) order. In other examples, the items are assigned in accordance with a user-selected pick-up time, such that items for orders to be picked up earlier are assigned first and items for orders to be picked up at a later time are assigned last.

The intake area is an area within the item selection area in which the user can drop-off items the user has retrieved. The intake area 220 is a location at which items are scanned and sorted. Intake areas can be located at various locations within the item selection area of a store or other retail environment.

The user 120 can optionally also receive retrieval instructions 218 associated with the set of assigned items 216. The retrieval instructions 218 can include retrieval criteria specifying a maximum amount of time for retrieving one or more of the items in the set of assigned items 216 and/or other retrieval criterion, such as the retrieval criteria 132 in FIG. 1.

The retrieval instructions 218 can include a maximum amount of time for retrieving each item, in which each item has a different maximum retrieval time. For example, the user can be assigned a retrieval time of twenty minutes for a gallon of milk and a retrieval time of one hour for a bag of apples.

The retrieval time in other examples is the same retrieval time for all the items assigned to the user. For example, the retrieval time for both a gallon of milk and a bag of apples is thirty minutes. In still other examples, the retrieval instructions also include directions and/or a map indicating a location of each item in the list of items.

If the user agrees to retrieve the set of assigned items 216 in accordance with the retrieval instructions, the user 120 items conforming to the set of assigned items 216 and the retrieval instructions 218 are picked up from the item selection area 200 by the user. The items selected by the user are dropped off at the intake area 220 by the user 120. The set of retrieved items 222 includes the one or more items delivered to the intake area by the user 120 on behalf of one or more remote recipients is a.

The intake area 220 is an area located within the item selection area 200 where a user can deliver retrieved items in the item selection area. The intake area 220 can be a single intake area within an item selection area. In other examples, the item selection area can include two or more intake areas within the item selection area.

In other examples, the intake area 220 can be located within a proximity or threshold distance to the item selection area 200, such as near an entrance or exit point of the item selection area or in an adjacent area. A set of sensor devices 140 generates sensor data associated with each item in the set of retrieved items 222 delivered to the intake area 220. The sensor data is analyzed to verify item identification and time of drop-off at the intake area. This data is used to verify order fulfillment by the user.

In some examples, the set of sensor devices 140 includes one or more hand-held scanners for a user to manually scan each item dropped off at the intake area 220. In other examples, the set of sensor devices 140 includes one or more automatic scanning devices for automatically scanning items dropped off at the intake area 220. The automatic scanning devices can optionally include a smart conveyor that scans and sorts items into orders/totes to verify and complete order. Any items not conforming to a requested item is rejected and returned to an assigned display area for the item or a storage area for the item.

The request fulfillment component analyzes the sensor data generated by the set of sensor devices to determine whether each item in the set of retrieved items 222 conforms to the set of assigned items 216 and the retrieval instructions 218. Each item in the set of retrieved items 222 that conforms to the assigned items 216 and the retrieval instructions 218 are accepted by the request fulfillment component. If an item in the set of retrieved items 222 fails to match an item in the set of assigned items 216 and/or an item is not retrieved in accordance with retrieval instructions 218, the request fulfillment component rejects the item.

In some examples, items received at the intake area that are rejected by the intake component are added back into the plurality of requested items for assignment to another user. In other words, if a first user retrieves an item which does not conform to quality standards and/or other retrieval criteria, the rejected item is assigned to another user for retrieval. If insufficient time remains, an associate or other order-filler personnel can be assigned to retrieve the rejected item.

The set of sensor devices 140 is a set of one or more sensor devices for identifying an item delivered to the intake area 220, identifying a time of delivery of an item to the intake area 220, and/or evaluating a quality of an item delivered to the intake area 220. The set of sensor devices 140 in some examples includes one or more scanners 228. A scanner can be implemented as a radio frequency identifier (RFID) tag reader, a barcode reader, a universal product code (UPC) reader, a matrix barcode reader, a beacon receiver, or any other type of scanner device. A scanner in the one or more scanners 228 can include a hand-held scanner, as well as a mounted scanner.

The set of sensor devices 140 can also include one or more image capture devise, such as, but not limited to, one or more camera(s) 230. Image data generated by the camera(s) 230 is analyzed by the request fulfillment component running on the computing device 102 to identify items and/or determine a quality of the items. For example, image data can be analyzed to identify items that are damaged, have ripped packaging, smashed, or otherwise poor quality.

The computing device 102 in these examples analyzes the sensor data generated by the set of sensor devices 140 to identify the items retrieved by the user 120. In other examples, the computing device 102 sends the sensor data to a remote server which analyzes the sensor data to identify quality and accuracy of the items retrieved by the user 120.

In other examples, the intake area 220 includes a computing device 102 associated with one or more order-fillers preparing orders for one or more recipients of one or more items in the set of items retrieved by the user 120. The computing device 102 can output a feedback prompt 234 to the one or more order-fillers requesting feedback 236 from the order-filler(s) associated with the accuracy and quality of items retrieved by the user 120.

In some examples, the user 120 selects a set of one or more items 238 for the user 120 to keep. The set of items 238 includes items selected by the user 120 for purchase by the user 120. The user can purchase the set of items 238 via a transaction completed at one or more point-of-sale (POS) devices 240. In other examples, the user 120 completes a transaction associated with purchase of the set of items 238 via an application running on the user device 118.

In some examples, the user retrieves the one or more items from the item selection area 200 using a cart 224, basket, shopping bag, or other container for transporting the items. The cart 224 is any type of shopping cart or basket on wheels in this non-limiting example. The user can keep the set of items 238 for the user to keep in one area of the cart 224 and the set of retrieved items to be delivered to the intake area 220 in a separate area of the cart 224. In other examples, the user has a first cart for the set of items 238 the user intends to purchase and a second cart for the set of retrieved items 222 for delivery to the intake area 220.

In some examples, the intake area receives one or more items retrieved by the user. One or more sensor devices associated with the intake area scans the one or more received items to identify the items and/or determine whether the one or more items conform to one or more requested items for partial order fulfillment. The sensor data generated by the one or more sensor devices is analyzes for the item identification and/or analysis of the item quality for assortment and order-filling.

FIG. 3 is an exemplary block diagram of a request fulfillment component 114. In some examples, the request fulfillment component 114 includes a selection component 302. The selection component 302 selects one or more items from a plurality of requested items for retrieval by an identified user within an item selection area, such as the user 120 in FIG. 1 and/or FIG. 2.

In some examples, the selection component 302 analyzes user-provided data 116 with the selection criteria to select one or more items from the plurality of requested items for retrieval by a particular user. In other words, the items selected for retrieval by the user are customized for each user based on the user-provided data 116.

In some examples, the user-provided data 116 includes a list of items 214 for the user, such as, but not limited to, the user-provided list of items 214 in FIG. 2. In these examples, the selection component 302 selects items for retrieval that match or correspond to one or more items on the list of items 214 provided by the identified user in the user-provided data 116. The list of items 214 is a list of one or more items the user plans to select for purchase and/or user by the user.

In other examples, the user-provided data 116 includes user preferences, such as the set of user preferences 802 in FIG. 8 below. The user preferences can indicate items the user prefers to retrieve for remote recipients and/or items the user prefers not to retrieve for remote recipients. Items the user prefers not to retrieve can be referred to as negative preferences. For example, if a user is a vegan, the user preferences can indicate the user prefers not to retrieve meat or other animal products. In another example, if the user has a peanut allergy, the user preferences can indicate the user prefers not to retrieve peanut-related items. In still another example, if the user is a teetotaler, the user preferences can indicate the user prefers not to retrieve beverages containing alcohol.

In some example, the list of items is output to the user with an accept or reject query asking the user to indicate which items the user agrees to retrieve within the retrieval time allotted for item retrieval. The retrieval time can be a per-item time or a retrieval time for all the items in the list of items. The user can accept all the items in the list, accept none of the items in the list, or accept one or more of the items. The user can likewise reject all the items, none of the items, as well as reject one or more of the items.

An assignment component 308 assigns at least one item in the set of requested items to the identified user with retrieval criteria associated with the at least one item in response to receiving an acceptance 310 of the at least one item by the identified user. If a user rejects one or more of the items in the set of requested items, the rejected item is removed from the set of items to be assigned to the user. The set of one or more assigned items 312 accepted by the user is assigned to the identified user. The assigned set of items is output to the user via a user interface component or via a user device associated with the user.

The assignment component 308 removes items assigned to a user for retrieval from the plurality of requested items to prevent assignment of the same item to two or more users. In other examples, when an item is assigned to a user for retrieval, the assignment component adds a marker or identifier to the item in the plurality of requested items indicating that retrieval of the is in progress but has not yet been received at an intake area. This prevents retrieval of duplicate/unnecessary items.

In some examples, if a threshold number of an item is rejected by the user a threshold number of times, the system assigns a per-item restriction for the rejected item to the user to prevent the rejected item from being offered to the user for retrieval on future occasions/future visits to the store. For example, if the threshold number of rejections is two and the identified user rejects a ground-beef item from a set of requested items offered to the user twice, the user is assigned a ground-beef item restriction.

In other examples, if a threshold number of a given item a category is rejected by the user, the system assigns a per-item restriction for the rejected item is assigned to the user to prevent the rejected category of items from being offered to the user for retrieval on future occasions. For example, if the threshold number of rejections is four and the identified user rejects four different soda/soft drink items from a set of one or more requested items offered to the user on one or more occasions, the user is assigned a soda/soft drink category restriction.

In other examples, a restriction is assigned to the user if the user rejects an item or category of items a threshold number of times. For example, if the user rejects retrieval of all candy items from a threshold number of visits to a store, a per-category restriction for candy is assigned to the user.

An intake component 314 analyzes sensor data 316 associated with one or more retrieved items received at an intake area to determine whether the retrieved item(s) corresponding to one or more items in the set of assigned items 312. The intake component 314 accepts 318 each item retrieved by the user and delivered to the intake area that conforms to an item identified in the set of assigned items 312. The intake component 314 rejects 320 each item retrieved by the user and delivered to the intake area that fails to conform to an item identified in the set of assigned items 312 and/or fails to conform with retrieval criteria, such as the retrieval criteria 132 in FIG. 1.

A scoring component 322 generates a retrieval score for the identified user based a level of compliance with the retrieval criteria associated with the set of retrieved items received at the intake area and the number of items in the set of assigned items that were correctly retrieved and delivered to the intake area within the assigned retrieval time.

The scoring component 322 in some examples calculates the score based on a quality of items retrieved and an accuracy of items retrieved. The accuracy refers to whether the item retrieved is of the correct number, size, variety, brand, etc. For example, if a remote user ordered a ten-ounce (10 oz.) size juice bottle and the identified user retrieves a sixteen-ounce (16 oz.) size juice bottle, the item retrieved is incorrect regarding the size. Likewise, if a remote user requests a twenty-four-ounce (24 oz.) bottle of lemonade and the identified user selects a twenty-four-ounce bottle of strawberry lemonade, the variety is wrong. In still another example, if the remote user requests three packages of laundry detergent, but the identified user only retrieves two of the packages of laundry detergent, then the number/quantity is wrong.

In some examples, the retrieval score is a per-item retrieval score 324 indicating a retrieval ranking for a specific item. For example, the scoring component 322 can generate a bread retrieval score indicating a quality of bread items retrieved by a given user on one or more occasions. If a loaf of bread retrieved by the user is stale, smashed, the packaging is torn, or the bread is otherwise of poor quality, the assigned per-item retrieval score 324 is a low score (outside an acceptable threshold score range). If a loaf of bread retrieved by the user is soft and otherwise of good quality, the per-item retrieval score 324 can be a high score (score within an acceptable threshold range).

The scoring component 322 in other examples generates a per-category retrieval score 326 for a user. For example, if the user retrieves canned-items that are dented, have torn labels, or missing labels, the scoring component 322 can generate a per-category retrieval score 326 for canned items that is low (outside an acceptable range) indicating canned items retrieved by the user are of poor quality. However, if the user consistently retrieves canned items that are not dented and otherwise of good quality, the per-category retrieval score 326 is a higher score (within an acceptable score threshold range). In this example, the canned items category can include canned vegetables, canned fruit, canned sauces, canned meat, canned milk, and/or any other items packaged in a can.

In another example, if a user retrieves cupcakes which are smashed, have melted frosting, or turned upside down, the user is assigned a score outside the acceptable retrieval score threshold indicating poor item selection associated with cupcakes. In other examples, the user is assigned an item-restriction prohibiting assignment of cupcakes to the user on future item selections based on the unacceptable item retrieval score.

In still other examples, the scoring component 322 generates a per-user retrieval score 328. The per-user retrieval score 328 is an overall item retrieval score for all items retrieved by the user on one or more occasions. The per-user retrieval score 328 indicates general compliance with item retrieval criteria and conformity of retrieved items with assigned items. In other words, the per-user retrieval score 328 indicates whether a user typically retrieves the correct item, size, variety, pack-size, number of items, brand of item, compliance with retrieval time limitations, etc.

A feedback component 330 in some examples sends a feedback query 332 to a user device associated with a remote recipient receiving one or more items retrieved by a given user and/or a user device associated with an order-filler preparing an order for at least one recipient that includes at least one item in the set of retrieved items retrieved by the identified user. The scoring component 322 generates the retrieval score(s) for a user based on the feedback 236 received by the feedback component.

In some examples, the feedback 236 received from the recipient(s) and/or the order-filler includes feedback indicating quality of the at least one item retrieved by the identified user. In other examples, the feedback 236 indicates accuracy of the items retrieved. In other words, if the requested item was for two half-gallon cartons of whole milk and the user retrieved one gallon of whole milk, the retrieved item as not the correct size or number of items. In this case, negative feedback can be received indicating the items retrieved were not the same as the items assigned to the user for retrieval.

The feedback 236 in some examples includes rating or indication of quality of items selected. For example, if a user selects apples with soft spots or green bananas, the feedback 236 will include negative feedback with a poor/negative rating. If the user selects unbruised bananas and ripe apples without soft spots, the user will receive positive feedback 236 with a positive rating.

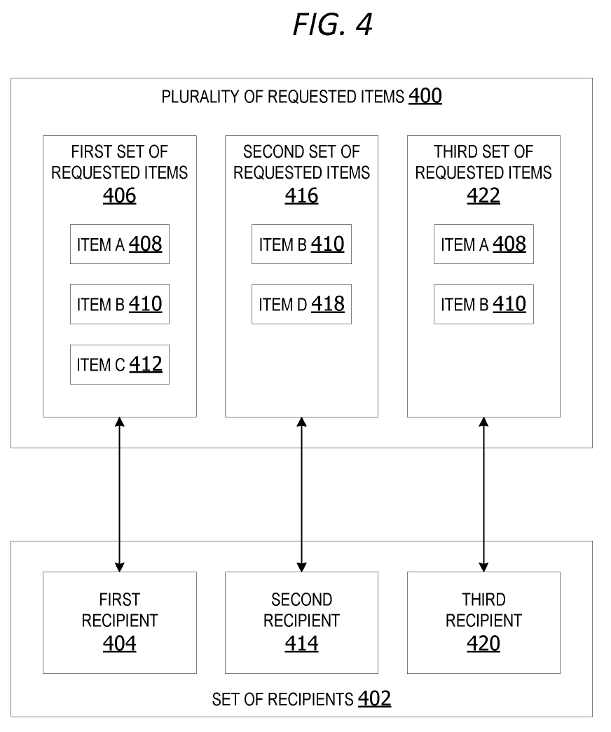

FIG. 4 is an exemplary block diagram illustrating a plurality of requested items 400 associated with one or more recipients. The plurality of requested items 400 includes two or more items requested in two or more orders made by two or more recipients in a set of recipients 402. In this example, a first recipient 404 requests a first set of requested items 406 including at least one instance of item “A” 408, one or more instances of item “B” 410, and one or more instances of item “C” 412. For example, if item “A” is a carton of soy milk and item “B” is a package of size AA batteries, the first set of requested items can include one carton of soy milk and two packages of the size AA batteries.

A second recipient 414 requests items in a second set of requested items 416. The second set of requested items 416 in this non-limiting example includes at least one instance of item “B” 410 and one or more instances of item “D” 418. Likewise, a third recipient 420 in this example requested a third set of requested items 422 including one or more instances of item “A” 408 and one or more instances of item “B” 410.

In some examples, the plurality of requested items available for assignment to a user for retrieval from the item selection area includes all instances of item “A” 408, item “B” 410, item “C” 412, and item “D” 418 requested in the first set of requested items 406, the second set of requested items 416, and the third set of requested items 422 which have not yet been retrieved and delivered to an intake area for order-fulfillment.

For example, if item “B” 410 is a loaf of bread, and the first set of requested items 406, the second set of requested items 416, and the third set of requested items 422 each include a request for one loaf of bread, the plurality of requested items 400 includes three loaves of bread available for assignment to a user for retrieval. If a given user is selected to retrieve item “B” 410, the user is assigned to retrieve all three instances of item “B” (three loaves of bread). However, the same given user may or may not be assigned to retrieve item “A” 408, item “C” 412, or item “D” 418. Thus, in this non-limiting example, a single is assigned to retrieve multiple instances of an item requested by two or more remote recipients for partial fulfillment of two or more orders.

In another example, if item “A” is a can of carrots and item “D” 418 is a can of peas, the same user can be assigned to retrieve all instances of item “A” requested in the first set of requested items 406 and the third set of requested items 422, as well as all instances of item “D” 418 requested in the second set of requested items due to the proximity of canned peas and canned carrots within an item selection area. However, the user assigned to retrieve item “A” and “D” in this example, may not be assigned to retrieve item “B” 410 and item “C” 412 if those items are not located within a predetermined distance (proximity) to items “A” and item “D”.

In still another example, a single user can be assigned to retrieve all the instances of the items 408, 410, 421, and 418 to fulfill all three of the orders for first recipient 404, the second recipient 414, and the third recipient 420. In another example, a first user can be assigned to retrieve all instances of item “A” 408 and item “D” 418 while a second user is assigned to retrieve all instances of item “B” 410 and item “C” 412 to fulfill all three of the orders for first recipient 404, the second recipient 414, and the third recipient 420.

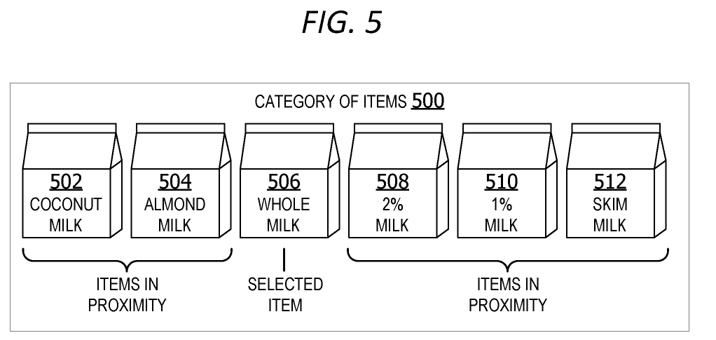

FIG. 5 is an exemplary block diagram illustrating a category of items 500. The category of items 500 is a milk category in this example. However, the examples are not limited to milk categories. Item categories can include bread, meat, canned items, baby items, clothing items, toys, video games, tools, garden supplies, pet supplies, soft drinks, candy, produce, or any other category for items.

The milk category in this non-limiting example includes coconut milk 502, almond milk 504, whole milk 506, two-percent milk 508, one-percent milk 510, and skim milk 512. A milk category is not limited to the items shown in FIG. 5. In other examples, a milk category includes items not shown in FIG. 5.

Items in the milk category can be assigned to a user based on items in a user-provided list of items to be obtained by the user for purchase by the user, such as in a shopping list. If a user-provided list of items includes a selected item of white milk 506, the user can be assigned multiple additional instances of whole milk 506 to be retrieved by the user. For example, if the plans to get one gallon of whole milk, the request fulfillment component can assign five additional gallons of whole milk to be retrieved by the user for fulfillment of one or more grocery orders made by one or more remote recipients. In this manner, the user is only assigned to retrieve items for other recipients that are the same or similar to items the user is already planning to obtain from the store. Therefore, the user is not required to expend additional time or effort locating items the user was not planning to get from the store. This reduces time expended by the user retrieving items and reduces frustration which can occur when a sought-after item cannot be located due to the user's unfamiliarity with the store or the item being sought after.

In another example, if a user-provided list of items includes the selected item of whole milk 506, the item request component assigns one or more instances of other items in the same category as the whole milk. In this example, coconut milk 502, almond milk 504, whole milk 506, two-percent milk 508, one-percent milk 510, and skim milk 512 are all assigned to the same category. Therefore, any instances of the coconut milk 502, almond milk 504, whole milk 506, two-percent milk 508, one-percent milk 510, and skim milk 512 in the plurality of requested items can be assigned to the user. In this manner, the user is only assigned to retrieve items in the same category as items the user already plans to obtain from the store.

In still another example, if a user-provided list of items includes the selected item of whole milk 506, the item request component assigns one or more instances of other items located within a proximity of the whole milk item 506. In other words, the system identifies requested items assigned to a location that is within a predetermined distance from one or more items on the user-provided list, such as the whole milk 506.

In this example, coconut milk 502, almond milk 504, whole milk 506, two-percent milk 508, one-percent milk 510, and skim milk 512 are all assigned to a same or similar location in a refrigerated display. The coconut milk 502, almond milk 504, whole milk 506, two-percent milk 508, one-percent milk 510, and skim milk 512 are located within the predetermined distance from the whole milk 506. Therefore, any instances of the coconut milk 502, almond milk 504, whole milk 506, two-percent milk 508, one-percent milk 510, and skim milk 512 in the plurality of requested items can be assigned to the user. In this manner, the user is only assigned to retrieve items located near one or more items the user already plans to obtain from the store. This eliminates wasted time and effort spend by the user roaming around a store searching for an unfamiliar item. Assigning items in the same category or location as items the user already plans to purchase likewise improves user satisfaction and simplifies the item retrieval process.

A category of items in other examples includes items of a same or similar type. For example, a dairy category can include milk, butter, cheese, yogurt or other milk-based items. In this example, if a user-provided list of items includes butter, the system can assign milk, butter, yogurt, cheese, or other dairy items in the milk category to the user for retrieval by the user for grocery order fulfillment.

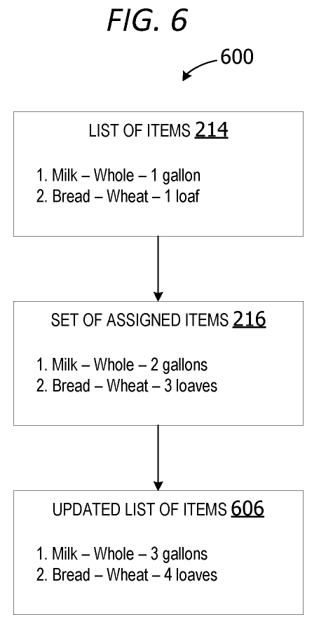

FIG. 6 is an exemplary block diagram illustrating update of a user-provided list of items 214. In this non-limiting example, a user provides a list of items 214 the user intends to obtain in the item selection area of a store or other environment. In this non-limiting example, the list of items 214 includes one gallon of whole milk and one loaf of wheat bread. The request fulfillment component selects items from the plurality of requested items that match/correspond to one or more items on the user-provided list of items 214. In other words, the request fulfillment component assigns the user to retrieve additional instances of items already on the user's shopping list. Here, the set of assigned items 312 includes two additional gallons of whole milk and three additional loaves of wheat bread for the user to retrieve and deliver to an intake area.

In some examples, the request fulfillment component provides an updated list of items 606 for the user to retrieve which includes both the items identified in the user-provided list of items 214 and the set of assigned items 312 assigned to the user. In this example, the updated list of items 606 includes three gallons of whole milk. The three gallons of milk include one gallon for the user to keep in accordance with the user's own shopping list and two additional gallons of milk for the user to deliver to the intake area. The updated list of items 606 also includes four loaves of wheat bread. The four loaves of wheat bread include one loaf of bread for the user and three loaves of bread for the user to drop-off at the intake area.

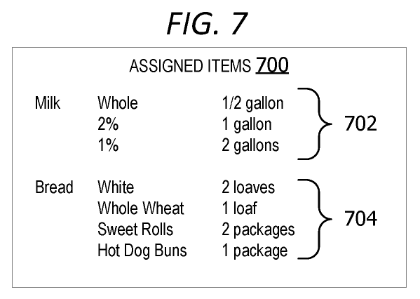

FIG. 7 is an exemplary block diagram illustrating assigned items 700 associated with a list of items, such as the list of items 600 in FIG. 6 above. The assigned items 700 is a non-limiting example of a set of one or more items assigned to a user for retrieval, such as, but not limited to, the set of assigned items 216 in FIG. 2, FIG. 3 and/or FIG. 6.

In some examples, the system assigns items to a user based on a category of items in a user-provided list of items. For example, if the user-provided list of items includes a half-gallon of almond milk, the assignment component assigns items from the plurality of requested items from the same category as the almond milk. In this example, the user can be assigned to retrieve items 702 in the milk or dairy category, such as, but not limited to, whole milk, two-percent milk, one-percent milk or any other requested items in the same category as the almond milk the user intends to obtain.

Likewise, if the user-provided list of items includes a loaf of white bread, the assignment component can assign items in the same bread/bakery category as the white bread. In this non-limiting category, the user is assigned items 704 from the bread/bakery category, including two additional loaves of white bread, a loaf of whole wheat bread, two packages of sweet rolls, and a package of hot dog buns.

In other examples, the assignment component assigns items to a user for retrieval that are located within a predetermined distance or proximity to one or more items on the user-provided list of items. In this example, the items 702 are items located within a predetermined distance from the almond milk on the user-provided list of items. Likewise, the items 704 are items located within the predetermined distance from the loaf of white bread identified in the user-provided list of items as an item the user plans to buy.

The items in the assigned items 700 can be utilized to fulfill a single order from a single requesting third-party, such as, but not limited to, the remote recipient 124 in FIG. 1. In other examples, the items from the assigned items 700 retrieved by the user is used to fill multiple different grocery orders from two or more different requesting third-parties.

FIG. 8 is an exemplary block diagram illustrating a computing device 102 executing a priority component 802 for selecting a user having a highest retrieval score 804. The priority component 802 selects a user, such as user 806 or 808, from a set of one or more users 810 available to retrieve one or more items from an item selection area. In this example, the selection component 302 recognizes two or more identified users, 806 and 808, qualified and available to retrieve one or more items. The system does not assign multiple users to retrieve the same item in this example to prevent retrieval of duplicate items or retrieval of unwanted items. Therefore, where two or more users are available and qualified to retrieve the same item, the selection component 302 selects the user having the highest retrieval score 804. In this example, the selection component 302 selects user 806 from the set of users 810 to retrieve the item.

In other examples, where two or more users are available to retrieve the same item, the item is assigned to the user having the greatest amount of time available for item retrieval. In other examples, the item is assigned to a user having the same item or same category of items included in a user-provided shopping list.

A retrieval score is a score indicating a quality and/or accuracy of item retrieval performed by a given user on one or more previous occasions. A retrieval score indicating a level of accuracy and quality associated with previous sets of items retrieved by an identified user.

The retrieval score is generated based on the accuracy of items retrieval. The accuracy reflects how closely a retrieved item correspond to an assigned item. If the user is assigned to retrieve a brand of an item, flavor/variety, size, and number of instances of the item, the accuracy indicates how well the item(s) retrieved match the brand, variety, size, and/or number criteria assigned to the user.

The retrieval score in other examples also reflects quality of items retrieved. The quality can include package integrity, expiration dates, produce freshness, ripeness of selected fruit, etc. For example, if a can of fruit is dented or a bag of chips has a hole in it, the package integrity is poor. If fruit selected by a user is over-ripe (brown bananas) or unripe (green bananas), the score generated for the user is lower to reflect the poor quality of the items selected. Likewise, if the user selects bagged salad or milk that has reached an expiration date, the score can be lower to reflect those issues as well.

The retrieval score is generated for each user by a scoring component, such as the scoring component 322 in FIG. 3. The retrieval score can be generated based on feedback provided by a recipient of the items or an order-filler using the retrieved items to fill an order. The retrieval scores for each user are stored in a database 814 in this example. The database 814 is a data structure associated with a data storage, such as, but not limited to, the data storage device 136 in FIG. 1.

The set of scores 816 includes retrieval score(s) 818 for each unique user which has retrieved at least one assigned item on at least one occasion. In this example, one or more retrieval scores 818 are stored for a user 820 and one or more retrieval scores 822 are stored for a different user 824. The one or more retrieval scores can include a per-user score, a per-category score, and/or a per-item score.

In this example, the priority component 802 identifies a selected user 826 having the highest retrieval score 804 associated with each user available to retrieve one or more items, a category 828 of an item to be assigned for retrieval, and/or the selected item 830 to be retrieved. In other words, if the item to be retrieved is a bag of apples, a user can be selected that has a highest per-user retrieval score, the user having the highest produce category score, and/or the user having the highest retrieval score for apples.

In some examples, only one score is used to select the user. For example, the user having the highest per item score is chosen. In other examples, the user having the highest per-category score is chosen. In still other example, the user having the highest per-user score is chosen.

Two or more scores can be used in other examples to select a user. For example, the user having the highest of all three scores is selected. In other words, the user has the highest per-user score, per-category score, and per-item score is chosen. The user having a highest per-item score and per-user score can be chosen. In other examples, the user having the highest per-category score and per-item score are chosen. The user having the highest per-user score and per-category score can be selected in other examples.

A set of user preferences 802 is a set of one or more user-provided item retrieval preferences. A user preference can include a positive preference indicating items the user prefers to retrieve. A user preference can also include a negative preference 836 indicating an item 832 the user prefers not to retrieve. For example, the negative preference 836 can indicate that the user prefers not to retrieve bacon.

In other examples, the user preferences indicate a negative preference 836 for a category 834 of items. For example, the user can indicate in user-provided data that the user is a diabetic and prefers not to retrieve candy or any items in the candy category.

FIG. 9 is an exemplary block diagram illustrating assignment of incentives 902 to a user for retrieval of items by the user. A request fulfillment component 114 analyzes sensor data 316 generated by a set of one or more sensors associated with one or more intake areas to evaluate the quality and accuracy of retrieved items selected by the user. The sensor data can be generated by sensor devices associated with an intake area, such as the set of sensor devices 140 in FIG. 1 and/or FIG. 2.

The sensor data 316 in other examples also include data generated by sensors associated with the plurality of items in the item selection area, such as the item selection area 200 in FIG. 2. A retrieval-time calculator component 906 analyzes the sensor data 316 and/or context data 908 associated with the item selection area to generate a dynamic retrieval time 910 for one or more items in the plurality of requested items.

The context data 908 is data associated with current conditions within the item selection area. The sources of the context data can include a weather feed, news feed, current events calendars, the sensor data 316, and/or the database 814. The context data 908 in some examples is analyzes to determine current and/or predicted foot traffic 912 and congested areas 914 within the item selection area.

The dynamic retrieval time 910 is an estimated time required to retrieve an item from a display area assigned to the item in the item selection area. For example, if a requested item is a package of baby diapers, the dynamic retrieval time 910 is an estimated amount of time required for a user to walk to the assigned modular location (assigned display area) for the package of baby diapers, and then deliver the item to an intake area that is nearest to the location of the baby diapers. If there are multiple intake areas associated with the item selection area, the dynamic retrieval time 910 can include an estimated time to retrieve the item and take it to the intake area nearest to the assigned location of the baby diapers.

Multiple intake areas can be provided within the item selection area to prevent a bottle-neck associated with retrieved item drop-offs by multiple users. Likewise, multiple drop off locations enable users to drop-off items as the identified user retrieves these items. This enables the user to quickly retrieve items. Moreover, if there is only a single intake area, the user can waste time trying to locate it. With multiple intake areas, the user is more likely to locate at least one intake area more quickly and with less effort.

The dynamic retrieval time 910 is calculated in real-time based on foot traffic and/or congested areas within a store or other item selection area, as well as any other changing environmental factors which can influence the time for item retrieval. For example, if the aisles are relatively empty, the retrieval time can be three minutes. However, if the aisles near the location of the baby diapers are congested with a significant number of other people, the retrieval time can increase to four or five minutes due to the increased foot traffic and/or obstructions in the aisles.

In other examples, the dynamic retrieval time 910 is generated based on a location of one or more items, a location of one or more intake areas, a location of one or more items on the user-provided list of items, a map of the item selection area, the number of items on the user-provided list of items, the time of day, day of the week, month, season, restocking schedules, store traffic patterns, and/or any other context data.

The user-provided amount of time available for retrieving items is compared with the dynamic retrieval time 910 for each item in the plurality of items to be retrieved. The assignment component selects items for retrieval by a given user that have a dynamic retrieval time 910 that is less than the user-provided time available for retrieving items.

In other examples, a pre-determined retrieval time 916 for each item is utilized instead of the dynamic retrieval time 910. The predetermined retrieval time 916 is a static retrieval time calculated based on average conditions within the item selection area.

The predetermined retrieval time 916 can be stored in a database 814 for storing data. The database 814 can be implemented as a relational database, filesystem, or any other type of data storage.

The database 814 can include other item retrieval related data, such as, but not limited to, rewards account(s) 920, retrieval score(s) 922, and/or restriction(s) 924. The rewards account(s) 920 includes a rewards account for each user. The rewards account(s) 920 include a record of incentives 902 assigned to each user for retrieving items. The incentives 902 can include coupons, discounts, freebie items, reward points, store credit, cash incentive, or any other type of incentive. An incentive discount can be a discount on a single item or a discount on an entire purchase amount.

In some examples, an incentive is not assigned to the user until a threshold time-period has passed to enable the recipient of the retrieved items to send feedback indicating the quality and accuracy of the items retrieved. For example, an incentive can be output twenty-four hours after the item retrieval to enable sufficient time for feedback/evaluation of the quality of the items retrieved. In other examples, the incentive is output to the user on the user's next visit to the store. In still other examples, the incentive is output to the user when the user makes a next purchase of one or more items at the store.

Retrieval score(s) 922 include one or more retrieval scores assigned to each user. A retrieval score can include a per-user score, a per-category score, and/or a per-item score. Restriction(s) 924 can include one or more restrictions assigned to a user. A restriction is a prohibition indicating that a given user is not approved for retrieving an identified item or items in a classification or category. The restriction(s) 924 can restrict a user from all item retrievals.

A restriction can be assigned to a user if the user receives negative feedback associated with an item or category of items. A restriction can also be assigned if the user fails to retrieve items conforming to assigned items and/or retrieval criteria.

In some examples, an incentives generation component 926. The incentives generation component 926 analyzes item promotion data 928, an accepted number of items 930, inventory data 932, and/or transaction history data 934 to identify one or more incentives 902 to assign to the user as a reward for retrieving one or more items and delivering the item(s) to at least one intake area within an assigned amount of retrieval time.

The item promotion data 928 is data associated with promotions for one or more items in the plurality of items available within the item selection area to identify one or more items to offer as an incentive. The accepted number of items 930 is the number of items retrieved by the user and delivered to at least one intake area that conforms to one or more assigned items and the retrieval criteria. In other words, the accepted number of items 930 is the number of correct items retrieved by the user which can be used for at least partial fulfillment of one or more orders. The accepted number of items 930 can include the number of items which qualify the user to receive an incentive. The number of rejected items is the number of non-conforming items delivered to the intake area.

In some examples, the retrieval score generated for a given user is calculated based on the number of accepted items and the number of rejected items retrieved by the user. If the user retrieves many non-conforming items, the retrieval score is lower or falls outside the accepted threshold. As the number of accepted items increases, the retrieval score increases.

Inventory data 932 is data associated with items in current inventory. Inventory data 932 can be utilized to determine if there is a surplus of any items in inventory. Items having a surplus inventory can be identified for use as an incentive, either for a discount or a free item.

The transaction history data 934 is historical transaction data for a given user. The transaction history data 934 can identify items purchased by the user on previous occasions. A customized incentive for a given user can be identified based on items purchased by the user in the past. For example, if the user frequently purchases a particular brand of toothpaste, that brand of toothpaste can be offered to the user as an incentive for retrieving one or more items.

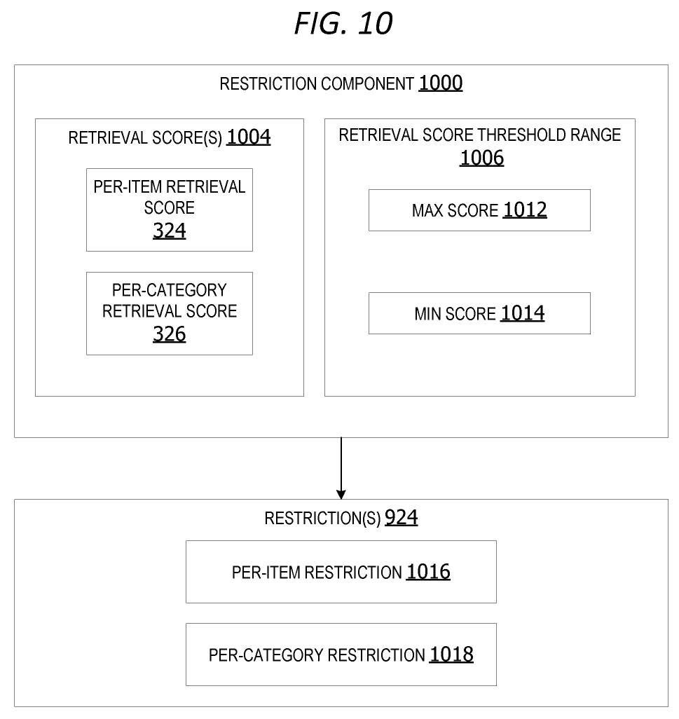

FIG. 10 is an exemplary block diagram illustrating a restriction component 1000 for assigning restriction(s) 924 to one or more users. The restriction component 1000 analyzes retrieval score(s) 1004 for a given user based on a retrieval score threshold range 1006 to identify restriction(s) 924 to be assigned to the given user. The retrieval score(s) 1004 can include a per-item retrieval score 324 and/or a per-category retrieval score 326 for a given item retrieved by the user. The restriction component 1000 analyzes the retrieval score(s) 1004 associated with at least one item assigned to the identified user for retrieval using the retrieval score threshold range 1006. The retrieval score threshold range 1006 in some examples includes a maximum (MAX) score 1012 and/or a minimum (MIN) score 1014. In other examples, the retrieval score(s) 1004 can be compared to a single threshold value rather than a threshold range of values.

The retrieval score threshold range 1006 can include a threshold range for per-item retrieval score 324 and a different threshold range for the per-category retrieval score 326. In other examples, the same retrieval score threshold range 1006 can be utilized to analyze both pre-item scores and per-category scores both.

The restriction component 1000 in some examples assigns a per-item restriction 1016 to the user on condition the per-item retrieval score 342 falls outside the retrieval score threshold range 1006. The restriction component 1000 in other examples assigns a per-category restriction 1018 to the user on condition the per-category retrieval score 326 falls outside the retrieval score threshold range 1006.

The per-item restriction 1016 prohibits assignment of a selected item to the identified user for retrieval. For example, if the user retrieves one or more loaves of bread that receives poor feedback and/or fails to conform to retrieval criteria on one or more occasions, the user can be assigned a per-item restriction prohibiting assignment of bread to the user for future item retrieval assignments.

The per-category restriction 1018 prohibits assignment of any items within a selected category to the identified user for retrieval. For example, if an identified user is assigned a per-category canned-goods restriction, the user is restricted from retrieving canned goods. In this example, the identified user is not assigned to retrieve canned-goods items because previous canned goods items retrieved by the user did not conform to retrieval criteria or were not the same as the items requested.

A restriction is assigned based on item retrieval score(s) assigned to the user in some examples. If a user receives a poor or low produce retrieval score which is outside an acceptable threshold range/below a minimum threshold, the system assigns a per-category produce restriction precluding assignment of produce items to the user for retrieval.

An item can be different than requested if the item is the wrong size, wrong item count, wrong variety, or other attribute. For example, if a requested item is a can of unsalted peanuts and the user retrieves a can of salted peanuts, the item is the wrong variety. Likewise, if a requested item is for twelve-count box of canned soda and the user retrieves a twenty-four-count box of canned sodas, the item is the wrong item-count. Likewise, if a requested item is the twelve-ounce box of cereal and the user retrieves an eighteen-ounce size, the item is the wrong size.

In other examples, a per-category score and/or a per-item score is utilized to determine whether to assign a given item to a user without any restrictions 924. In these examples, the score is compared with a threshold score value to determine whether the score is acceptable. For example, if a requested item is a package of rolls, the assignment component can compare a per-category score for a bread/bakery category assigned to the user with a threshold score to determine whether to assign the package of rolls to the user for retrieval. If the score is above the threshold, the package of rolls is assigned. If the score is below the threshold, the package of rolls is not assigned to the user.

In another example, if there is a per-item score associated with bread rolls for the user, the assignment component can assign the package of bread rolls to the user if the per-item score for bread rolls assigned to the user is above the threshold. However, if the per-item score for bread rolls is below the threshold, the assignment component does not assign the package of rolls to the user.

In one example, the per-item score trumps the per-category score. Thus, if the per-category score for bread/bakery items is an acceptable score but the per-item score for rolls is an unacceptable score based on the threshold score values, the assignment component does not assign the package of rolls to the user.

In another example, an unacceptable per-category score trumps the per-item score. In this example, even if the per-item score for bread rolls is an acceptable score, the package of rolls is not assigned to the user if the user is also assigned an unacceptable per-category score for bread/bakery items. Thus, a negative or unacceptable per-item score or a per-category score can be used to disqualify a user from retrieving an item associated with those scores.

FIG. 11 is an exemplary block diagram illustrating a database 814 storing item retrieval data. The item retrieval data can include user-provided data 116. The user-provided data 116 can include available time 1104 for the user to retrieve items and user preferences 802. The user preferences 802 include items the user prefers to retrieve and/or items the user prefers not to retrieve.

In other examples, the user preferences 802 include negative preferences indicating a user prefers not to retrieve items or categories of items, such as, but not limited to, peanuts, candy, milk, soy, meat, animal products, alcoholic beverages, or any other item or category of items. For example, if a user is on a dairy-free diet, the user preferences 802 can indicate that the user does not want to retrieve items in the dairy category.

The database 814 can also include item data 1108 associated with the one or more items in the plurality of requested items. The item data 1108 includes an assigned location 1110 of the item in the item selection area, a category 1112 for the item, and a retrieval time 1114 for retrieving the item. The retrieval time 1114 can be a dynamic retrieval time calculated based on current conditions within the item selection area or a predetermined (static) retrieval time.

The item data 1108 can also include a predetermine distance 1116 between item locations. The predetermined distance 1116 can specify a distance between assigned item locations and/or an identification of items located within the predetermined distance of each other.

In some examples, an item is assigned to the user for retrieval if the item is located within a predetermined distance from at least one item on the user-provided shopping list. In other examples, an item is assigned to the user for retrieval if the item is located within a predetermined distance from a current location of a user device associated with the user, such as the user device 118 in FIG. 1.

Retrieval history data 1118 is data associated with retrieval of items by a user. The retrieval history data 1118 can include one or more retrieval score(s) 1120 for the user. The score(s) 1120 can include current retrieval score(s) 1122 for the user and/or previous retrieval score(s) 1124 for the user. The retrieval history data 1118 can also include restrictions 924 assigned to the user and/or incentives history 1128. The incentives history 1128 includes a history of incentives assigned to the user.

A set of order(s) 1130 can include one or more orders. The first (1^{st}) order 1132 in this non-limiting example includes an item “A” 1134, an item “B” 1136, and an item “C” 1138. The second (2^{nd}) order 1140 in this example includes another instance of item “A” 1134 and item “D” 1142. A third (3^{rd}) order 1144 includes another instance of item “A” 1134 and another instance of item “B” 1136. The fourth (4^{th}) order 1146 includes item “E” 1148 and another instance of item “A” 1134.

Each of the instances of items in the set of order(s) 1130 are included in the plurality of requested items to be assigned to one or more users for retrieval. A user can be assigned to retrieve all the items in the first order 1132 or assigned to retrieve one or two of the items in the first order 1132.

For example, one user can be assigned to retrieve all four instances of item 1134 for all four of the orders in the set of order(s) 1130 while another user is assigned to retrieve the two instances of item 1136, one instance of item D 1142 and one instance of item “E” 1148. In other examples, a different user is assigned to retrieve each different item. For example, a first user can retrieve the four instances of item 1134, a second user can retrieve the two instances of item 1136, a third user can retrieve item 1138, a fourth user can retrieve item D 1142, and a fifth user can retrieve item 1148. In still another example, a single user can be assigned to retrieve all instances of items 1134, 1136, 1138, 1142, and 1148 for fulfillment of all the orders in the set of order(s) 1130.

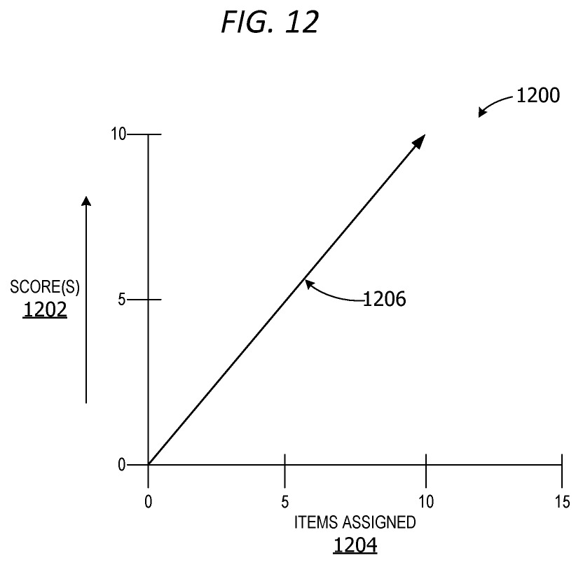

FIG. 12 is an exemplary graph 1200 illustrating item assignment based on per-user retrieval scores 1202 for retrieval of items assigned 1204 to the user. A per-user retrieval score is a score, such as, but not limited to, the per-user retrieval score 328 in FIG. 3.

The graph 1200 demonstrates that as a user's retrieval score increases, the user is trusted to retrieve more items in some examples. Therefore, the number of items assigned to the user increases. Likewise, as the number of items assigned to the user are successfully retrieved by the user in other examples, the user's retrieval score increases, as shown at 1206.

FIG. 13 is an exemplary flow chart illustrating operation of the computing device to assign items to a user for retrieval based on user-provided data. The process shown in FIG. 13 can be performed by a request fulfillment component 114, executing on a computing device, such as the computing device 102 in FIG. 1, FIG. 2 and/or FIG. 8.

The process beings by selecting an item at 1302, such as an item in the set of requested items 128 in FIG. 1, the plurality of items 202 in FIG. 2, and/or the plurality of requested items 400 in FIG. 4. In some examples, the item is selected from a plurality of requested items by a selection component, such as the selection component 302 in FIG. 3 and/or FIG. 8.

The selection component determines whether sufficient time is available for the user to retrieve the selected item at 1304. If yes, the selection component determines whether assignment of the item to the user is restricted by one or more restrictions assigned to the user at 1306. The per-item or per-category restrictions can include restrictions, such as, the restriction(s) 924 in FIG. 9, FIG. 10, and/or FIG. 11.

If the per-item restriction or the per-category restriction prevents assignment of the item, the item is removed from the set of assigned items at 1314. In other words, the selected list of requested items is redacted or updated to remove the restricted items from the list.

In some examples, if the selected item is restricted by a per-item restriction, the item is removed from the set of assigned items for the user. In other examples, if a category of the selected item is restricted by a per-′ restriction, the item is removed from the set of assigned items. The set of assigned items is a set of one or more items for assignment to the user, such as, but not limited to, the set of assigned items 216 in FIG. 2, FIG. 3, and/or FIG. 6.

The selection component determines if a next item is available at 1312. If no, the process terminates thereafter.

Returning to 1306, if the item is not restricted, the selection component determines if user preferences agree with assignment of the item to the user at 1308. The user preferences include one or more user-provided preferences associated with retrieving items, such as, but not limited to, the set of user preferences 802 in FIG. 8 and/or FIG. 11. If the user preferences indicate a negative preference associated with the item, the selection component removes the item from the set of assigned items at 1314. The selection component determines whether a next item is available at 1312.

Returning to 1308, if user preferences agree with assignment of the item, an assignment component assigns the item to the user at 1310. The selection component determines whether a next item is available for assignment. If yes, the process returns to 1304.

If sufficient time is not available for the user to retrieve the item based on the user-provided amount of time available and the estimated retrieval time for the item, the item is removed from the set of assigned items at 1314. The selection component determines whether a next item is available at 1312.

The operations 1304 through 1312 are iteratively executed until no additional items remain for assignment at 1312. The process terminates thereafter.

While the operations illustrated in FIG. 13 are performed by a computing device, aspects of the disclosure contemplate performance of the operations by other entities. For example, a cloud service can perform one or more of the operations.

FIG. 14 is an exemplary flow chart illustrating operation of the computing device to assign items to a user for retrieval based on an item on a user-provided list of items of the user. The process shown in FIG. 14 can be performed by a request fulfillment component 114, executing on a computing device, such as the computing device 102 in FIG. 1, FIG. 2 and/or FIG. 8.

A user-provided list of items is received at 1402. A selected item in the provided list of items is identified at 1404. The user-provided list of items is a shopping list, such as the list of items 214 in FIG. 2, FIG. 3 and/or FIG. 6.

The selected item is compared to a plurality of requested items to be retrieved for a set of remote recipients at 1406. The plurality of requested items includes one or more requested items, such as the set of requested items 128 in FIG. 1 and/or the plurality of requested items 400 in FIG. 4. The selection component determines if the selected item matches any item in the plurality of requested items at 1408. If no, the process terminates thereafter.

If a selected item in the user-provided list of items matches an item in the plurality of requested items, at least one additional instance of the selected item is assigned to the user for retrieval by the user at 1410. The process terminates thereafter.

While the operations illustrated in FIG. 14 are performed by a computing device, aspects of the disclosure contemplate performance of the operations by other entities. For example, a cloud service can perform one or more of the operations.

FIG. 15 is an exemplary flow chart illustrating operation of the computing device to assign items to a user for retrieval based a category of an item on a user-provided list of items of the user. The process shown in FIG. 15 can be performed by a request fulfillment component 114, executing on a computing device, such as the computing device 102 in FIG. 1, FIG. 2 and/or FIG. 8.

A category of an item in a user-provided list is identified at 1502. The category is a type, grouping, or classification for two or more items, such as category of items 500 in FIG. 5, category 834 and/or category 828 in FIG. 8 and/or the category 1112 in FIG. 11. The selection component identifies a category for each item in a plurality of requested items at 1504. A selection component determines if any category for requested items matches a category for the item in the user-provided list at 1506. If no, the process terminates thereafter.

If a category of an item in the user-provided list matches a category of any items in the plurality of requested items, the matching items in the category matching the category of the item in the user-provided list is assigned to the user at 1508. The process terminates thereafter.

While the operations illustrated in FIG. 15 are performed by a computing device, aspects of the disclosure contemplate performance of the operations by other entities. For example, a cloud service can perform one or more of the operations.

FIG. 16 is an exemplary flow chart illustrating operation of the computing device to assign items to a user for retrieval based on a location of an item on a user-provided list of items of the user. The process shown in FIG. 16 can be performed by a request fulfillment component 114, executing on a computing device, such as the computing device 102 in FIG. 1, FIG. 2 and/or FIG. 8.

A selection component identifies a location of each item in a plurality of requested items at 1602. The location is an assigned display area, shelf, end-cap display, or other assigned location for an item in the item selection area of a store, such as the location 1110 in FIG. 11. A location of each item in a user-provided list of items is identified at 1604. The selection component determines if any items in the user-provided list are located within a predetermined distance to any items in the plurality of requested items at 1606. The predetermined distance if a distance from the location of an item in the user-provided list of items and the location of an item in the plurality of required items, such as the predetermined distance 1116 in FIG. 11. If no, the process terminates thereafter.

If any items are located within the predetermined distance from a location of an item on the user-provided list, an assignment component assigns the item(s) to the user at 1608. The process terminates thereafter.

While the operations illustrated in FIG. 16 are performed by a computing device, aspects of the disclosure contemplate performance of the operations by other entities. For example, a cloud service can perform one or more of the operations.

FIG. 17 is an exemplary flow chart illustrating operation of the computing device to assign items to a user for retrieval based on a retrieval score for the user. The process shown in FIG. 17 can be performed by a request fulfillment component 114, executing on a computing device, such as the computing device 102 in FIG. 1, FIG. 2 and/or FIG. 8.

A selection component determines if a retrieval score is available at 1702. If yes, the selection component determines if the score is above a threshold at 1704. If the user's retrieval score is below the threshold, the process terminates thereafter.

Returning to 1704, if the score is above the threshold, an identification of one or more requested item(s) is output to the user at 1706. The item(s) to be retrieved can be output in a list via a user interface component, such as the user interface component 110 in FIG. 1. In other examples, a list of the item(s) to be retrieved can be output to a remote computing device associated with the user via a network, such as the network 112 in FIG. 1.

An assignment component determines if the user accepts all the output items at 1708. If yes, the assignment component assigns all the output items to the user for retrieval at 1710. The process terminates thereafter.

Returning to 1702, if a score for the user is unavailable, the identification of the item(s) is output to the user at 1706. If the user does not accept all the items at 1708, the assignment component determines if the user accepts at least one item from the output item(s) at 1712. If the user does not accept any items at 1712, the process terminates thereafter.

Returning to 1712, if the user accepts at least one item, the assignment component assigns the one or more accepted item(s) to the user at 1714. The process terminates thereafter.

While the operations illustrated in FIG. 17 are performed by a computing device, aspects of the disclosure contemplate performance of the operations by other entities. For example, a cloud service can perform one or more of the operations.

FIG. 18 is an exemplary flow chart illustrating operation of the computing device to assign an item to a user for retrieval based on per-item retrieval score assigned to the user. The process shown in FIG. 18 can be performed by a request fulfillment component 114, executing on a computing device, such as the computing device 102 in FIG. 1, FIG. 2 and/or FIG. 8.

The process begins by selecting an item at 1802 for assignment to a user. The item is selected by a selection component in some examples. The selection component is a component for identifying requested items for retrieval by an identified user, such as the selection component 302 in FIG. 3.

The selection component determines if there is a category score for the user at 1804. The category score is a per-category retrieval score, such as the per-category retrieval score 326 in FIG. 3 and/or FIG. 10. If yes, a determination is made whether the per-category score is above a threshold at 1806. If yes, a determination is made whether there is an item score for the user at 1808. The item score is a per-item retrieval score such as the per-item retrieval score 324 in FIG. 3 and/or FIG. 10. If yes, a determination whether the item score is above a threshold is made at 1810. If yes, the item is assigned to the user at 1812 and the process terminates thereafter.

If the category score is not above the threshold, the selection component removes the item from the set of items to be assigned to the user at 1814 and the process terminates thereafter.

Returning to 1808, if the category score is above the threshold and there is no item score at 1808, an assignment component assigns the item to the user at 1812. The assignment component is a component for assigning items to a user for retrieval, such as the assignment component 308 in FIG. 3. The process terminates thereafter.

If the item score is not above the threshold at 1810, the item is removed at 1816 from the set of items assigned to the user. Thus, even if a per-category score indicates a user can retrieve the item, the item is not assigned to the user if a per-item score associated with the user is below the threshold. The process terminates thereafter.

While the operations illustrated in FIG. 18 are performed by a computing device, aspects of the disclosure contemplate performance of the operations by other entities. For example, a cloud service can perform one or more of the operations.

FIG. 19 is an exemplary flow chart illustrating operation of the computing device to generate a retrieval score and/or restriction for a user based on retrieval criteria associated with a retrieved item. The process shown in FIG. 19 can be performed by a request fulfillment component 114, executing on a computing device, such as the computing device 102 in FIG. 1, FIG. 2 and/or FIG. 8.

The process begins by receiving an item at an intake area at 1902. The item received at the intake area is detected and/or identified by an intake component in some examples, such as the intake component 314 in FIG. 3. The intake component determines if retrieval criteria are met 1904. If yes, the item is accepted by the intake component at 1906. An incentives generation component outputs a reward to the user at 1908. The incentives generation component is a component for generating a customized reward for a user based on the number of items retrieved by the user, quality of the items retrieved, and/or compliance with retrieval criteria, such as the incentives generation component 926 in FIG. 9. A per-item score and/or a per-category score is generated for the user at 1910. The process terminates thereafter.

Returning to operation 1904, if the retrieval criteria for the item is not met, the intake component is rejected at 1912. The intake component outputs a rejection notification at 1914. A per-item restriction or a per-category restriction is generated at 1916. The per-item restriction and/or per-category restriction is a user customized restriction, such as, but not limited to, the restriction(s) 924 in FIG. 9, FIG. 10 and/or FIG. 11. The process terminates thereafter.

While the operations illustrated in FIG. 19 are performed by a computing device, aspects of the disclosure contemplate performance of the operations by other entities. For example, a cloud service can perform one or more of the operations.

FIG. 20 is an exemplary flow chart illustrating operation of the computing device to generate a retrieval score and/or a restriction(s) based on feedback associated with an item retrieved by the user. The process shown in FIG. 20 can be performed by a request fulfillment component 114, executing on a computing device, such as the computing device 102 in FIG. 1, FIG. 2 and/or FIG. 8.

The process begins by obtaining feedback associated with an item retrieved by a user at 2002. In some examples, the feedback is obtained by a feedback component, such as the feedback component in FIG. 3. The feedback component analyzes the feedback to generate a per-item score and/or a per-category score at 2004. The incentives generation component determines if the generated score is above a threshold at 2006. If the score is above the threshold, the incentives generation component assigns an incentive to the user at 2008. If the score is below the threshold, a restriction component assigns a per-item restriction and/or a per-item category to the user at 2010. The restriction component is a component for analyzing retrieval scores and assigning restrictions to user based on the scores, such as the restriction component 1000 in FIG. 10. The process terminates thereafter.

While the operations illustrated in FIG. 20 are performed by a computing device, aspects of the disclosure contemplate performance of the operations by other entities. For example, a cloud service can perform one or more of the operations.

### Additional Examples

Some examples provide a crowd-sourced system for item selection by users in a store. Items are assigned to a user based on the user's available time, preferences, shopping list, feedback, score/rating, and/or restrictions assigned to the user. The system uses sensor data to determine whether correct items are selected in accordance with retrieval criteria and dropped-off in a timely manner. The system generates incentives for crowd-source shoppers based on accepted items, feedback, and/or per-user score/ranking.

The system assigns one or more items from a plurality of requested items from one or more different grocery orders to a single user for retrieval in other examples. The items retrieved by the user are utilized to partially fill one or more of the orders. Thus, in some examples, items from multiple orders are assigned to a single user based on items in the user's own shopping list. Thus, items for filling a single order can be retrieved by multiple different shoppers. Likewise, a single shopper can retrieve only some of the items requested in a single order or retrieve some of the items to partially fill two or more items.

In an example scenario, items are assigned to a user for retrieval which are identical to an item on the user's shopping list. In another example, items are assigned to the user for retrieval which are located within a proximity of one or more items on the user's shopping list. In still another example, items are assigned to a user for retrieval which are classified within the same classification as one or more items on the user's shopping list. In yet other examples, items are assigned to a user for retrieval which are not prohibited by the own user's preferences and/or retrieval restrictions assigned to the user.

In other examples, a user waiting for a service, such as a pharmacy customer waiting for a prescription to be filled or a car-service customer waiting for an oil change or other car maintenance service can elect to retrieve one or more items for grocery order fulfillment during the wait time. The user can also choose to retrieve requested items while waiting for a ride to come and pick them up from the store. The system assigns items having a per-item estimated retrieval time which allows the user to retrieve those items during the estimated wait time in exchange for a reward. In this manner, the user can occupy their time usefully.

In some examples, an alert or alarm is sent to the user device to notify the user that a retrieval time for one or more items is about to expire. The alert is sent a threshold amount of time prior to the expiration of the retrieval time. In some examples, the threshold amount of item is ten minutes. In this example, the alarm or alert includes a ten-minute warning that the retrieval time for an item is about to expire in ten minutes. In another example, the threshold amount of time can be five minutes. In that example, the system outputs a five-minute warning to the user notifying the user that the retrieval time for an item is about to expire in five minutes. The examples are not limited to a five-minute or ten-minute warning time. The threshold amount of warning time can be any user-configurable amount of time prior to expiration of an item retrieval time.

If one or more items are not delivered to an item intake area within the assigned item retrieval time by an identified user, the item assignment to the identified user is canceled and the one or more items are assigned to another user or store personnel for retrieval. This ensures all items are retrieved in a timely manner for delivery to the one or more remote recipients.

The request fulfillment component in other examples enables crowdsources partial order fulfillment with lower costs and reduced labor by store employees. The automatic request fulfillment also increases personnel available within the store to assist customers while improving overall efficiency of order-filling.

In other examples, users receive incentives which are commensurate with the number of items they retrieve and the accuracy of item retrieval. Users receive rewards for improved accuracy and quality of items to improve user satisfaction and order verification.

A centralized item intake is provided in some examples via one or more item intake areas located at various locations within a store for scanning and sorting retrieved items. In other examples, the system sends items to a backroom sorter for item intake to build and store totes in ambient, chilled, and frozen areas. Shopping sortation for picks (dividers) can be utilized with pick list optimization logic for crowdsourced order filling.

In one non-limiting example, a user having a mobile user device running the item assignment application arrives at a store. The request fulfillment component prompts the user to pick items located near items already on the user's shopping list (user-provided list of items). If the user accepts one or more items for retrieval, the system downloads an updated shopping list which includes the one or more accepted items assigned to the user for retrieval. The user picks the items and scans the items when placing the items in the shopping cart. The item can be scanned using a hand-held scanner or the user device.

In some examples, as the user scans each retrieved item before placing the item in the cart, the scanner sends the scan data to the request fulfillment component. The request fulfillment component analyzes the scan data to identify requested items already selected by the user and placed in the user's cart but not yet dropped off at an intake area. In this manner, the request fulfillment component knows which items have been selected and expected to be dropped off at an intake area and which items have not yet been located/found by the user yet. The request fulfillment component can re-assign items to a different user if the request fulfillment component does not receive scan data for an item indicating it has been picked up by a user by a per-item maximum item selection time. In other words, if the user does not find an item and scan it within the item selection time, the item can be re-assigned to another user. Likewise, if the item is not delivered to an intake area within the per-item retrieval time, the item can be re-assigned to another user. If an item is re-assigned to a second user, the item assignment to the first user is canceled.

The user completes the shopping list in the item assignment application. The item assignment application prompts the user to drop-off items at one or more item intake areas. The item intake area scans the items to be sorted and validated for retrieval criteria compliance. The items are compiled into totes for order fulfillment in a backroom. The request fulfillment component generates and outputs incentives to the user as a reward for each item retrieved that is accepted at the intake area(s).

In some examples, if a threshold number of requests for the same item is received, the item is assigned to personnel to retrieve due to the high number of instances of the item requested. For example, if there are twenty open orders that include at least one carton of eggs, rather than assign a single user to retrieve the twenty cartons of eggs, an associate or other personnel is assigned to retrieve a case containing twenty cartons of eggs from a backroom and deliver the case to the intake area. This improves efficiency of item retrieval.

If one or more items assigned to a user for selection are not scanned within a maximum item selection time, the item is re-assigned to another user. Likewise, if an item assigned to a user is not received at an intake area within a per-item maximum retrieval time (within a threshold time-period), the items are re-assigned to another user or store personnel for retrieval. This ensures all items are retrieved in a timely manner for accurate on-line order fulfillment.

A user entering a store or other item selection area is identified in some examples based on a user device associated with the user. The user can also be identified using a user login, user identifier (ID), password, a rewards account, and/or any other type of user identification.

The system retrieves a score associated with a user profile for an identified user in one non-limiting example. If the user score is within an acceptable threshold range of scores, the identified user is approved for item retrieval. A list of one or more requested items is selected for the user based on user preferences and user restrictions assigned to the identified user. The user enters preferences via a user interface on a stand-alone kiosk or via a mobile user device. The system removes any items from the list that are restricted and items the user prefers not to retrieve. This enables customized item retrieval based on each user's preferences and scores/ratings for each item, item category, or overall item-retrieval rating.

In another non-limiting example, the system outputs a list of requested items with item retrieval time limits to a user interface associated with an identified user. The user interface can be a stand-alone kiosk, or an interface associated with a mobile user device. If the user rejects one or more of the items in the list, the system redacts the list to remove the rejected one or more items. The redacted list of requested items accepted by the user are output to the user via the user interface.

The system analyzes scan data and feedback received associated with items retrieved by the identified user to determine a quality and accuracy of the retrieved items in other examples. The system generates an updated score for the user based on the determined quality and accuracy of the retrieved items. The system outputs one or more incentives based on the updated score.

Alternatively, or in addition to the other examples described herein, examples include any combination of the following:
a feedback component, implemented on the at least one processor, that queries an order-filler preparing an order for at least one recipient that includes at least one item in the set of retrieved items retrieved by the identified user and queries a user device associated with a recipient of at least one item in the set of retrieved items for feedback regarding the quality of the at least one item retrieved by the identified user;
wherein the scoring component generates the retrieval score for the identified user based on the feedback provided by the order-filler and the at least one recipient;
a user interface component, implemented on the at least one processor, that receives user-provided data, the user-provided data comprising the user-provided list of items and an amount of time available for retrieving items;
wherein the at least one item assigned to the identified user has a predetermined retrieval time that is less than the amount of time available for item retrieval by the identified user;
wherein the retrieval score further comprises a per-item score, wherein an item associated with the per-item score is assigned to the identified user for retrieval if the per-item score is within an acceptable threshold range;
wherein the item associated with the per-item score is excluded from the at least one item assigned to the identified user for retrieval if the per-item score is outside the acceptable threshold range;
the scoring component identifies a category associated with an item in the set of retrieved items and generates a per-category score for the item based on feedback received from at least one of an order-filler associated with an intake area or a recipient receiving the item;
wherein items in the identified category are only assigned to the identified user if the per-category score generated for the identified user is within an acceptable threshold range;
wherein the identified user is disqualified from retrieving items within the identified category if the per-category score is outside the acceptable threshold range;
a user device associated with the identified user, wherein the selection component identifies an item in the plurality of requested items assigned to a location within the item selection area that is within a predetermined distance of a location assigned to a selected item on the user-provided list of items and adds the identified item to the selected set of requested items to be retrieved by the identified user;
wherein each item in the selected set of requested items is assigned to a location within the item selection area that is within a predetermined distance from a location of at least one item on the user-provided list of items;
a retrieval-time calculator component, implemented on the at least one processor, that analyzes sensor data and context data associated with the item selection area and generates a dynamic retrieval time for each item in the plurality of requested items;
wherein each item in the assigned set of items has a dynamic retrieval time that is less than a user-provided amount of time available for item retrieval by the identified user;
a restriction component, implemented on the at least one processor, that analyzes a retrieval score associated with at least one item assigned to the identified user using a retrieval score threshold range and assigning a per-item restriction or a per-category restriction to the user on condition the retrieval score falls outside the retrieval score threshold range;
wherein the per-item restriction prohibits assignment of a selected item to the identified user for retrieval;
wherein the per-category restriction prohibiting assignment of any items within a selected category to the identified user for retrieval;
generating, by an incentives generation component, an incentive for the identified user based on the retrieval score for the identified user;
outputting, by a feedback component, a feedback prompt to a recipient of at least one item in the set of requested items and an order-filler utilizing the at least one item retrieved by the identified user to complete an order for the recipient, the feedback prompt requesting feedback regarding quality of the at least one item;
generating, by the scoring component, the retrieval score for the identified user based on any feedback received from the recipient and the order-filler in response to the feedback prompt;
a set of preferences provided by the identified user, wherein the selection component removes a selected item from the selected set of requested items assigned to the identified user if the set of user preferences indicates a negative preference associated with the selected item;
wherein the retrieval score further comprises a per-category score for a selected category of items;
assigning items within the selected category of items to the identified user if the retrieval score is within an acceptable threshold range;
wherein the identified user is disqualified from retrieving items within the identified category if the per-category score is outside the acceptable threshold range;
analyzing sensor data obtained from a set of sensors associated with the item selection area to generate a dynamic item retrieval time for a selected item;
adding the selected item to the set of items to be retrieved by the identified user if the dynamic item retrieval time is less than the time available for the user to retrieve items;
identifying at least one item in the plurality of requested items matching at least one item on the user-provided list of items;
adding the at least one item in the plurality of requested items matching the at least one item in the user-provided list of items to the selected set of requested items to be retrieved by the identified user;
wherein each item in the selected set of requested items matches an item on the user-provided list of items provided by the identified user;
identifying a category associated with a selected item on the user-provided list of items;
adding each item in the plurality of requested items included within the identified category to the selected set of requested items, wherein each item in the selected set of requested items are included within a same category as a category of at least one item in the user-provided list of items provided by the identified user;
identifying at least one item in the plurality of requested items assigned to a location within the item selection area that is within a predetermined distance of a location assigned to a selected item on the user-provided list of items;
adding the at least one item in the plurality of items located within the predetermined distance of the location of the selected item to the selected set of requested items to be retrieved by the identified user;
wherein each item in the selected set of requested items is assigned to a location within the item selection area that is within a predetermined distance from a location of at least one item on the user-provided list of items;
a scoring component, implemented on the at least one processor, that generates a per-item score associated with the selected item and assigns the per-item score to the identified user;
wherein the per-item score is generated based on feedback received from at least one of an order-filler or at least one recipient receiving at least on instance of the selected item retrieved by the identified user;
a scoring component, implemented on the at least one processor, that generates a per-category score associated with a category of the selected item and assigns the per-category score to the identified user; and
the per-category score is generated based on feedback received from at least one of an order-filler or at least one recipient receiving at least on instance of the selected item retrieved by the identified user.

At least a portion of the functionality of the various elements in FIG. 1, FIG. 2, FIG. 3, FIG. 4, FIG. 5, FIG. 6, FIG. 7, FIG. 8, FIG. 9, FIG. 10, and FIG. 11 can be performed by other elements in FIG. 1, FIG. 2, FIG. 3, FIG. 4, FIG. 5, FIG. 6, FIG. 7, FIG. 8, FIG. 9, FIG. 10, and FIG. 11, or an entity (e.g., processor, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, and FIG. 11.

In some examples, the operations illustrated in FIG. 13, FIG. 14, FIG. 15, FIG. 16, FIG. 17, FIG. 18, FIG. 19, and FIG. 20 can be implemented as software instructions encoded on a computer readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for customized item selection in grocery order fulfillment. For example, the elements illustrated in FIG. 1, FIG. 2, FIG. 3, FIG. 4, FIG. 5, FIG. 6, FIG. 7, FIG. 8, FIG. 9, FIG. 10, and FIG. 11, such as when encoded to perform the operations illustrated in FIG. 13, FIG. 14, FIG. 15, FIG. 16, FIG. 17, FIG. 18, FIG. 19, and FIG. 20, constitute exemplary means for selecting a set of requested items from a plurality of requested items for retrieval by an identified user within an item selection area; exemplary means for assigning at least one item in the set of requested items to the identified user with retrieval criteria associated with the at least one item in response to receiving an acceptance of the at least one item by the identified user; exemplary means for identifying a set of retrieved items received at an intake area corresponding to the at least one item assigned to the identified user based on an analysis of sensor data received from at least one sensor device associated with the intake area and the retrieval criteria; exemplary means for generating a retrieval score for the identified user based a level of compliance with the retrieval criteria associated with the set of retrieved items received at the intake area; and exemplary means for generating an incentive for the identified user based on the number of items in the set of retrieved items accepted for at least partial fulfillment of at least one order and the generated retrieval score.

In another example, the elements illustrated in FIG. 1, FIG. 2, FIG. 3, FIG. 4, FIG. 5, FIG. 6, FIG. 7, FIG. 8, FIG. 9, FIG. 10, and FIG. 11, such as when encoded to perform the operations illustrated in FIG. 13, FIG. 14, FIG. 15, FIG. 16, FIG. 17, FIG. 18, FIG. 19, and FIG. 20, constitute exemplary means for receiving, user-provided data comprising a user-provided list of items and an amount of time available for item retrieval from a user device associated with a user; exemplary means for selecting a set of requested items from a plurality of requested items having a predetermined retrieval time within the amount of time available for item retrieval; exemplary means for outputting the selected set of requested items to the identified user in response to receiving an acceptance of at least one item in the set of requested items by the identified user; and exemplary means for removing any items rejected by the identified user from the selected set of requested items; exemplary means for accepting a set of retrieved items received by at least one intake area corresponding to at least one item in the selected set of requested items for at least partial fulfillment of at least one order; exemplary means for rejecting any items received by the at least one intake area failing to correspond to at least one item in the selected set of requested items; exemplary means for generating a retrieval score associated with the identified user; and exemplary means for indicating a level of conformity between the selected set of requested items assigned to the identified user for retrieval and the set of retrieved items received at the intake area via a retrieval score.

In another example, the elements illustrated in FIG. 1, FIG. 2, FIG. 3, FIG. 4, FIG. 5, FIG. 6, FIG. 7, FIG. 8, FIG. 9, FIG. 10, and FIG. 11, such as when encoded to perform the operations illustrated in FIG. 13, FIG. 14, FIG. 15, FIG. 16, FIG. 17, FIG. 18, FIG. 19, and FIG. 20, constitute exemplary means for identifying a set of users from a plurality of users within an item selection area available to retrieve a number of instances of a selected item based on a user-provided list of items provided by each user in the plurality of users; exemplary means for selecting a user from the set of users having a highest retrieval score associated with the identified item, a retrieval score indicating a level of accuracy and quality associated with previous sets of items retrieved by the identified user; exemplary means for updating a user-provided list of items to add the number of instances of the selected item to the user-provided list of items of the selected user; exemplary means for outputting the updated user-provided list of items, including the additional number of instances of the selected item, to a user device associated with the selected user; and exemplary means for assigning a customized reward to the selected user based on the number of instances of the selected item received at an intake area.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized item selection in grocery order fulfillment, the system comprising:
a memory;
at least one processor communicatively coupled to the memory;
a selection component, implemented on the at least one processor, that selects a set of requested items from a plurality of requested items for retrieval by an identified user within an item selection area, each item in the selected set of requested items corresponds to at least one item on a user-provided list of items provided by the identified user;
an assignment component, implemented on the at least one processor, that assigns at least one item in the set of requested items to the identified user with retrieval criteria associated with the at least one item in response to receiving an acceptance of the at least one item by the identified user;
an intake component, implemented on the at least one processor, that identifies a set of retrieved items received at an intake area corresponding to the at least one item assigned to the identified user based on an analysis of sensor data received from at least one sensor device associated with the intake area and the retrieval criteria;
a scoring component, implemented on the at least one processor, that generates a retrieval score for the identified user based a level of compliance with the retrieval criteria associated with the set of retrieved items received at the intake area; and
an incentives generation component, implemented on the at least one processor, that generates an incentive for the identified user based on a number of items in the set of retrieved items accepted for at least partial fulfillment of at least one order and the generated retrieval score.

2. The system of claim 1, further comprising:
a feedback component, implemented on the at least one processor, that queries an order-filler preparing an order for at least one recipient that includes at least one item in the set of retrieved items retrieved by the identified user and queries a user device associated with the at least one recipient for feedback regarding quality of the at least one item retrieved by the identified user, wherein the scoring component generates the retrieval score for the identified user based on the feedback provided by the order-filler and the at least one recipient.

3. The system of claim 1, further comprising:
a user interface component, implemented on the at least one processor, that receives user-provided data, the user-provided data comprising the user-provided list of items and an amount of time available for retrieving items, wherein the at least one item assigned to the identified user has a predetermined retrieval time that is less than the amount of time available for item retrieval by the identified user.

4. The system of claim 1, wherein the retrieval score further comprises a per-item score, wherein an item associated with the per-item score is assigned to the identified user for retrieval if the per-item score is within an acceptable threshold range, and wherein the item associated with the per-item score is excluded from the at least one item assigned to the identified user for retrieval if the per-item score is outside the acceptable threshold range.

5. The system of claim 1, wherein the retrieval score comprises a per-category score, and further comprising:
the scoring component identifies a category associated with an item in the set of retrieved items and generates the per-category score for the item based on feedback received from at least one of an order-filler associated with the intake area or a recipient receiving the item, wherein items in the identified category are only assigned to the identified user if the per-category score generated for the identified user is within an acceptable threshold range, and the identified user is disqualified from retrieving items within the identified category if the per-category score is outside the acceptable threshold range.

6. The system of claim 1, further comprising:
a user device associated with the identified user, wherein the selection component identifies an item in the plurality of requested items assigned to a location within the item selection area that is within a predetermined distance of a location assigned to a selected item on the user-provided list of items and adds the identified item to the selected set of requested items to be retrieved by the identified user, wherein each item in the selected set of requested items is assigned to a location within the item selection area that is within the predetermined distance from a location of at least one item on the user-provided list of items.

7. The system of claim 1, further comprising:
a retrieval-time calculator component, implemented on the at least one processor, that analyzes sensor data and context data associated with the item selection area and generates a dynamic retrieval time for each item in the plurality of requested items, wherein the dynamic retrieval time for each item assigned to the identified user is less than a user-provided amount of time available for item retrieval by the identified user.

8. The system of claim 1, further comprising:
a restriction component, implemented on the at least one processor, that analyzes the retrieval score associated with at least one item assigned to the identified user using a retrieval score threshold range and assigning a per-item restriction or a per-category restriction to the user on condition the retrieval score falls outside the retrieval score threshold range, wherein the per-item restriction prohibits assignment of a selected item to the identified user for retrieval, and wherein the per-category restriction prohibiting assignment of any items within a selected category to the identified user for retrieval.

9. A computer-implemented method for customized item selection in grocery order fulfillment, the computer-implemented method comprising:
receiving, from a user device associated with an identified user within an item selection area, user-provided data comprising a user-provided list of items and an amount of time available for item retrieval, the user-provided list of items comprising at least one item;
selecting, by a selection component, a set of requested items from a plurality of requested items having a predetermined retrieval time within the amount of time available for item retrieval, each item in the selected set of requested items corresponding to at least one item on the user-provided list of items;
outputting, by an assignment component, the selected set of requested items to the identified user in response to receiving an acceptance of at least one item in the set of requested items by the identified user, the assignment component removes items rejected by the identified user from the selected set of requested items;
accepting, by an intake component, a set of retrieved items received by at least one intake area corresponding to at least one item in the selected set of requested items for at least partial fulfillment of at least one order and rejecting any items received by the at least one intake area failing to correspond to at least one item in the selected set of requested items;
generating a retrieval score associated with the identified user, the retrieval score indicating a level of conformity between the selected set of requested items assigned to the identified user for retrieval and the set of retrieved items received at the at least one intake area.

10. The computer-implemented method of claim 9, further comprising:
generating, by an incentives generation component, an incentive for the identified user based on the retrieval score for the identified user.

11. The computer-implemented method of claim 9, further comprising:
outputting, by a feedback component, a feedback prompt to a recipient of at least one item in the set of requested items and an order-filler utilizing the at least one item retrieved by the identified user to complete an order for the recipient, the feedback prompt requesting feedback regarding quality of the at least one item; and
generating, by a scoring component, the retrieval score for the identified user based on any feedback received from the recipient and the order-filler in response to the feedback prompt.

12. The computer-implemented method of claim 9, wherein the user-provided data further comprises:
a set of preferences provided by the identified user, wherein the selection component removes a selected item from the selected set of requested items assigned to the identified user if the set of user preferences indicates a negative preference associated with the selected item.

13. The computer-implemented method of claim 9, wherein the retrieval score further comprises a per-category score for a selected category of items, and further comprising:
assigning items within the selected category of items to the identified user if the retrieval score is within an acceptable threshold range, wherein the identified user is disqualified from retrieving items within the selected category if the per-category score is outside the acceptable threshold range.

14. The computer-implemented method of claim 9, further comprising:
analyzing sensor data obtained from a set of sensors associated with the item selection area to generate a dynamic item retrieval time for a selected item; and
adding the selected item to an assigned set of items to be retrieved by the identified user if the dynamic item retrieval time is less than the time available for the user to retrieve items.

15. The computer-implemented method of claim 9 further comprising:
identifying at least one item in the plurality of requested items matching at least one item on the user-provided list of items; and
adding the at least one item in the plurality of requested items matching the at least one item in the user-provided list of items to the selected set of requested items to be retrieved by the identified user, wherein each item in the selected set of requested items matches an item on the user-provided list of items provided by the identified user.

16. The computer-implemented method of claim 9 further comprising:
identifying a category associated with a selected item on the user-provided list of items;
adding each item in the plurality of requested items included within the identified category to the selected set of requested items, wherein each item in the selected set of requested items are included within a same category as the identified category of the selected item on the user-provided list of items.

17. The computer-implemented method of claim 9, further comprising:
identifying at least one item in the plurality of requested items assigned to a location within the item selection area that is within a predetermined distance of a location assigned to a selected item on the user-provided list of items; and
adding the at least one item in the plurality of items located within the predetermined distance of the location of the selected item to the selected set of requested items to be retrieved by the identified user, wherein each item in the selected set of requested items is assigned to a location within the item selection area that is within the predetermined distance from a location of at least one item on the user-provided list of items.

18. A system for crowdsourced item retrieval in grocery order fulfillment, the system comprising:
a memory;
at least one processor communicatively coupled to the memory;
a data storage device storing a set of retrieval scores associated with each user in a plurality of users;
a selection component, implemented on the at least one processor, that identifies a set of users from a plurality of users within an item selection area available to retrieve a number of instances of a selected item based on a user-provided list of items provided by each user in the plurality of users, the identified item matches an item on the user-provided list of items for each user in the set of users;
a prioritization component, implemented on the at least one processor, that selects a user from the set of users having a highest retrieval score associated with the identified item, a retrieval score indicating a level of accuracy and quality associated with previous sets of items retrieved by an identified user;
an assignment component, implemented on the at least one processor, that updates a user-provided list of items to add the number of instances of the selected item to the user-provided list of items of the selected user;
a communications interface component, implemented on the at least one processor, that outputs the updated user-provided list of items, including the additional number of instances of the selected item, to a user device associated with the selected user; and
a customized reward generator, implemented on the at least one processor, that assigns a customized reward to the selected user based on the number of instances of the selected item received at an intake area.

19. The system of claim 18, further comprising:
a scoring component, implemented on the at least one processor, that generates a per-item score associated with the selected item and assigns the per-item score to the identified user, the per-item score is generated based on feedback received from at least one of an order-filler or at least one recipient receiving at least on instance of the selected item retrieved by the identified user.

20. The system of claim 18, further comprising:
a scoring component, implemented on the at least one processor, that generates a per-category score associated with a category of the selected item and assigns the per-category score to the identified user, the per-category score is generated based on feedback received from at least one of an order-filler or at least one recipient receiving at least on instance of the selected item retrieved by the identified user.
